(19) United States
(12) Patent Application Publication
(10) Pub. No.: US 2002/0123812 A1
(43) Pub. Date: Sep. 5, 2002

(54) Virtual assembly design environment (VADE)

(75) Inventors: Sankar Jayaram, Pullman, WA (US); Uma Jayaram, Pullman, WA (US); Yong Wang, Pullman, WA (US); Hrishikesh Tirumali, Ann Arbor, MI (US); Hiral Chandrana, Ames, IA (US); Hugh Ingram Connacher, Thurmont, MD (US); Kevin Lyons, Olney, MD (US); Peter Fred Hart, Sterling, VA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Washington State University Research Foundation.

(21) Appl. No.: 09/888,055

(22) Filed: Jun. 21, 2001

Related U.S. Application Data
(63) Continuation of application No. PCT/US99/30753, filed on Dec. 23, 1999.
(60) Provisional application No. 60/113,629, filed on Dec. 23, 1998.

(51) Int. Cl. G06F 19/00; G06K 9/00; G06T 15/00; G06T 17/00; G03B 21/60; G06T 13/00; G06T 15/70

(52) U.S. Cl. 700/98; 700/97; 700/95; 345/419; 345/420; 345/475; 359/458; 382/154; 706/919

(57) ABSTRACT

A virtual assembly design environment that simulates axial and planar constrained motion for multiple parts in any combination and application order. Dynamic simulation methods are used to simulate object behavior in the design environment using physical laws and collision detection algorithms. The physical properties, e.g., mass properties, of parts in an assembly are created in a separate CAD system. In one embodiment, physical property information is transferred from the CAD system to the virtual reality environment where it is used in dynamic simulations. The parts behave realistically in a user's hand, constrained on the base part, or moving freely in space. A swept volume can be generated directly in the CAD system. Real-time bi-directional data transfer between a VR environment and the CAD system is also provided. As a result, the user can perform parametric design modifications in the virtual environment by the use of a CAD system.

### CROSS-REFERENCES TO RELATED APPLICATIONS

This application is a Continuation of co-pending International Application No. PCT/US99/30753, filed on Dec. 23, 1999, which is a Continuation-in-Part of U.S. patent application No. 60/113,629, filed on Dec. 23, 1998, priority of the filing dates of which is hereby claimed under 35 USC §§120 and 119, respectively. Each of these applications is incorporated herein by reference.

### FIELD OF THE INVENTION

This utility patent application relates generally to the field of virtual reality (VR), and more specifically, to employing a virtual reality environment integrated with a computer aided design (CAD) system to simulate the virtual assembly of a finished product.

### BACKGROUND OF TEE INVENTION

Modern computer graphics began in the 1960s, when a “Sketchpad” application program was created and its possible uses for computer aided design were demonstrated. During the past several decades, computer aided design/computer aided manufacturing (CAD/CAM) technology has evolved from only being able to represent two-dimensional (2D) geometry to being able to display fully shaded detailed three-dimensional (3D) models. With the rapid increase in computing power and the continuing reduction in hardware cost, CAD/CAM is being used almost in every stage of product design and manufacturing and it has tremendously increased the productivity of many industries.

However, current CAD/CAM systems are still quite limited in their capabilities. Most CAD systems are limited in the design process due to an inability to enable interactive simulation and dynamic review of a product design. Moreover, it is increasingly apparent that there is a long felt need for a simpler way for an entire enterprise, i.e., management, engineering, manufacturing, maintenance and suppliers, to view and interact with a proposed design for a product. Historically, when an engineer wanted to further investigate the relationships between a proposed design model or a procedure of how to carry out the assembly or manufacture of the product, he used tools that were extensions of a traditional CAD/CAM system. For example, the engineer might use interactive visualization tools which can turn CAD data into functioning, interactive virtual products. These tools helped the engineer to understand the functionality, scale, clearances, ergonomics, and aesthetics of a new design.

Several advanced 3D visualization and digital prototyping tools are available on the market for use with CAD/CAM technology, e.g., VisMockUpTM from Engineering Animation Inc. and dVrealityTM from Division Inc. These high-speed, integrated 3D visualization tools are used across the conceptual, design, analysis and manufacturing phases of product development. Additionally, these visualization tools help facilitate a concurrent engineering process and reduce the amount of time necessary to introduce new products by reducing the number of physical prototypes that must be created. In this way, the engineering and design teams can more easily visualize their products, see the effects of changes and then communicate these effects in real time to others. Also, manufacturers can create, interact with, share, manipulate and analyze new designs prior to creating the physical prototype. The use of visualization tools with CAD/CAM technology increases interaction between different groups in an enterprise and helps to reduce the total time it takes for a new product to move from an initial concept to final manufacture.

Although the use of visualization tools with CAD/CAM technology is prevalent in many industries to improve design and manufacturing methods, the application of VR in the field of engineering is relatively new. However, the recent development of affordable and sophisticated VR hardware, i.e. tracking devices, displaying devices and tactile devices, has fueled the creation of VR applications for improving engineering design and manufacturing assembly tasks.

VR is a synthetic or virtual environment that gives a user a sense of reality, even though the virtual images of the environment may or may not exist in the real/physical world. VR employs an immersive user interface with real-time simulation and interactions through one or more sensorial channels, including visual, auditory, tactile, smell and taste. Additionally, virtual environment systems differ from traditional simulation systems in that they are much more flexible and reconfigurable because they rely much less on a physical mock-up/prototype for creating a realistic simulation. Also, virtual environment systems differ from other previously developed computerized systems in the extent to which real time interaction is facilitated, the perceived visual space is 3D rather than 2D, the user interface may be multi-modal, and the user is immersed in a computer generated virtual environment.

In the past, several attempts have been made to combine VR technology with traditional CAD/CAM system in different stages of product development from ergonomic studies, to design, assembly simulation, tele-operation and training applications. However, attempts to improve manufacturing planning with computer aided assembly planning systems have not, in general, been successful even when the design has been carried out using a CAD system. One of the main reasons for this lack of success is that assembly is dependent on a great deal of expert knowledge which is very difficult to formalize. Also, new products need to be more thoroughly analyzed for productability, quality and maintainability before committing the high capital required to produce physical prototypes of the new products.

Traditional automatic assembly planning methods have used the process of studying the disassembly process on the assumption that “if you can disassemble a part, you can assemble it, and vice versa”. In a real-world physical situation, this may not be true due to irreversible fastening processes. Also, for a given product, the number of feasible assembly sequences explodes exponentially as the number of components (parts) increases. In addition, choices of an optimal plan for disassembly may not represent the best plan for assembly. However, the present invention's use of VR opens up a powerful array of tools to solve this problem. Instead of abstract algorithmic assembly planning, an engineer can perform the assembly intuitively in a virtual environment using VR hardware and software. Also, the information generated by in a virtual assembly can be used for relatively precise assembly planning and verification in the real/physical world for a prototype of a new product.

### SUMMARY OF THE INVENTION

In accordance with the invention, a method is provided for a virtual environment for simulating the arranging of a plurality of parts into an assembly. A model is created in a design environment for each part. Each model corresponds to the geometry of a part and is translated into a virtual part in the virtual environment. The design environment is integrated with the virtual environment. Each virtual part can be positioned in the virtual environment. The positioning of each virtual part enables a simulation to be performed for arranging the plurality of parts into the assembly. The simulation can be modified which can enable another simulation to be performed. When the modification causes a change in the virtual part, the corresponding model automatically includes the change to the virtual part.

In accordance with additional aspects, the invention provides for enabling the automatic translation of different types of data from a computer aided design (CAD) system to a virtual assembly design environment (VAE) system. Assembly trees, assembly constraints, and geometry of the parts and subassemblies can be automatically translated from a parametric CAD system to the virtual environment provided by the Invention.

In accordance with yet other additional aspects, the invention provides for enabling the creation of a realistic virtual environment with an initial location of virtual parts that can be selected by a user. Also, the user can specify the type of assembly environment, which can be defined in the CAD system or imported from another system using any one of many standard file formats. The initial location and orientation of the virtual parts in the virtual environment can be specified by creating coordinate systems in the CAD system and transferring this coordinate information to the virtual environment.

In accordance with still other additional aspects, the invention provides for creating one or more virtual hands in the virtual environment that correspond to the real hands of a user and which are capable of one handed and/or two handed assembly of virtual parts and dexterous manipulations of these parts. In one embodiment, one of a pair of virtual hands that are provided in the virtual environment can be capable of dexterous manipulations that are controlled with a glove virtual reality device such as the CYBERGLOVE. The other one of the pair of virtual hands can be relatively non-dexterous and only capable of gross grabbing and manipulation movements of a “base” sub-assembly on to which virtual parts are to be assembled by the more dexterous virtual hand. Algorithms are used that allow the dexterous virtual hand to realistically grip 3D virtual parts using physics-based modeling and perform fine motor manipulations of a 3D virtual part. Additionally, the invention can produce different types of haptic feedback for a user including force, sound and temperature.

In accordance with other additional aspects, the invention provides for capturing constraint information employed by the user of the CAD system to create a 3D model of a part/assembly. This constraint information is employed to determine how the user probably intended the 3D models to be assembled. The constraint information is used to constrain and create kinematic motions for virtual parts during virtual assembly in the virtual environment. Also, the constraint information is used to create a suggested assembly sequence of the virtual parts to the user of the invention.

In accordance with yet other additional aspects, the invention provides for simulating the interaction between multiple virtual parts using constrained motions along determined and/or selected axes and planes. The virtual parts may be planar or axisymmetric. Also, the constraint information captured from the CAD system may be used to determine the axes and/or planes for constrained motion. This feature enables simulation of different motions such as sliding and rotating without having to employ computationally intensive numerical methods.

In accordance with still other additional aspects, the invention provides for interactive dynamic simulation of parts in a virtual environment using physically-based modeling information obtained directly from a CAD system that is used to create a 3D model. This information is used to enable collision detection in real time, simulation of dynamic behaviors of the parts held in a virtual hand controlled by the user, dynamic interactions between the virtual hand, part(s) held by the virtual hand, a base assembly, objects disposed in the virtual environment, simulation of ballistic motion of each object in space, and simulation of dynamic behaviors of the parts while constrained on the base assembly.

In accordance with other additional aspects, the invention provides for enabling a user to record the swept volume and trajectory of a virtual part as it is assembled in the virtual environment. The trajectory can be edited within the virtual environment. Also, the swept volume of the virtual part can be viewed in the virtual environment. The swept volume is created using numerical methods and this volume can be sent back to the CAD system.

In accordance with yet other additional aspects, the invention provides for parametric modifications of virtual parts in the virtual environment. Specific parameters for a 3D model can be tagged in the CAD system and these tagged parameters are extracted from the CAD system for display in the virtual environment as selectable options. When these tagged parameters are selected for modification in the virtual environment, the modifications are sent back to the CAD system where the 3D model of the virtual part is regenerated using all of the variational and parametric relations. The regenerated 3D model is reloaded from the CAD system into the VAE system for display as a virtual part with the selected modifications in real-time without the user ever having to leave the virtual environment. In this way, quick design changes and “what-if” evaluations during the assembly evaluation process can be performed.

In accordance with the invention, all of the above-described aspects can function individually or in any combination together. Constrained motion simulation is usually the default mode since it is the basic functionality for guiding assembly operation. Other aspects, such as swept volume generation, trajectory editing, collision detection, design modifications, and dynamic simulation are optional and the user can switch these features on and off as desired.

In accordance with yet still other additional aspects, the invention provides for the use of swept volume and collision detection together to determine whether a virtual part can be assembled safely (no collisions) without interfering with other parts or environment objects and where any interferences will occur in assembly (swept volumes). The combined use of the swept volume and collision detection features enables a user to identify the exact instances in the trajectory path of a virtual part that is colliding with other parts or environment objects. These exact instances can be employed to identify solutions and for editing the trajectory of the virtual part.

In accordance with other additional aspects of the invention, a system which implements substantially the same functionality in substantially the same manner as the methods described above is provided.

In accordance with yet other additional aspects of this invention, a computer-readable medium that includes computer-executable instructions may be used to perform substantially the same methods as those described above is provided.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a schematic overview of the usage scenario for the virtual assembly design environment;

FIG. 2 shows a schematic overview of object oriented modules of the virtual assembly design environment;

FIG. 3 illustrates a graphical user interface in the virtual assembly design environment for a constrained motion simulation of a virtual part along defined axes;

FIG. 4 shows a graphical user interface in the virtual assembly design environment for a dynamic motion simulation of a virtual pendulum shaped part that is rotating and translating about a shaft;

FIG. 5 illustrates a graphical user interface in a CAD environment for a swept volume with a parametric representation;

FIG. 6 shows a graphical user interface in the virtual assembly design environment for parametric design modification options in a context menu that is selected by a virtual right hand;

FIG. 7 illustrates a graphical user interface in the virtual assembly design environment for the simultaneous use of swept volume and collision detection;

FIG. 8 shows an overview of two parallel axial constraints applied in a plane;

FIG. 9 illustrates a schematic overview of a scene graph for the virtual assembly design environment when a part is held in the palm of a virtual hand;

FIG. 10 shows a schematic overview for the alignment and mating of axis and plane constraints;

FIG. 11 illustrates a schematic overview for alignment and mate differentiation of axis and plane constraints;

FIG. 12 shows a schematic overview for plane mating;

FIG. 13 illustrates a table that includes all possible combinations of axis and plane constraints;

FIG. 14 shows a schematic overview for snapping that does not destroy a previous constraint;

FIG. 15 illustrates a schematic overview for Case 1 of axis constraints on a part;

FIG. 16 shows a schematic overview for calculating the angle of rotation for a part;

FIG. 17 illustrates a schematic overview for Case 2 of axis constraints on a part;

FIG. 18 shows a schematic overview for calculating angles in Case 2 of axis constraints on a part;

FIG. 19 illustrates a schematic overview for Case 3 of axis constraints on a part;

FIG. 20 shows a schematic overview for calculating translation vectors in Case 3 of axis constraints on a part;

FIG. 21 illustrates a flowchart for the processing and application of multiple constraints;

FIG. 22 shows an overview of the class hierarchy of constraints;

FIG. 23 illustrates an overview of the constraints lists included in a part object;

FIG. 24 shows a flowchart of the exchange of information between a part object and the constraint manager;

FIG. 25 illustrates an overview of a scene graph of the virtual assembly design system when a part is attached to a base part;

FIG. 26 shows an overview of the virtual assembly design system when the part is released in free space;

FIG. 27 illustrates a flowchart for the constraint manager exchanging information with multiple parts;

FIG. 28 shows an overview of swapping applied constraints and unapplied constraints;

FIG. 29 illustrates a flowchart for displaying constraints during the process of assembly in the virtual assembly design environment;

FIG. 30 shows the format and content of an exemplary part file;

FIG. 31 illustrates an exemplary lifting capacity data sheet;

FIG. 32 shows a graphical representation of objects sliding on a plane and sliding on an axis;

FIG. 33 illustrates a schematic overview of the allowable direction computation for the cross product of two vectors;

FIG. 34 shows a schematic overview for rotation of a part about the part's center of mass;

FIG. 35 illustrates a schematic overview for computing a rotational vector about the center of mass of a part;

FIG. 36 shows a graphical representation of a part moving in any direction on a base part;

FIG. 37 illustrates a state transition diagram for a part;

FIG. 38 shows a graphical representation of a human eye following the motion of a dropping object;

FIG. 39 illustrates a graphical representation of an object penetrating a table top;

FIG. 40 shows a graphical representation of an object penetrating the geometry of a base part resting on a table top;

FIG. 41 illustrates a flow chart for swept volume generation using implicit modeling;

FIG. 42 shows a flow chart for swept volume generation within a CAD system using implicit modeling;

FIG. 43 illustrates a flow chart for automatic assembly and swept volume generation using a UDF method;

FIG. 44 shows a flow chart for swept volume instance removal;

FIG. 45 illustrates a flow chart for swept volume instance modification;

FIG. 46 shows a flow chart for design changes to a part within the CAD system;

FIG. 47 illustrates a flow chart for a non-parallel method of design modification in a virtual environment through the CAD system;

FIG. 48 shows a flow chart for a parallel method of design modification in the virtual environment through the CAD system;

FIG. 49 illustrates a flow chart for a parallel method of design modification in the virtual environment through the CAD system using shared memory;

FIG. 50 shows a pseudo code fragment for checking, setting and processing procedures in the virtual assembly design environment;

FIG. 51 illustrates a pseudo code fragment for checking, setting and processing procedures in the CAD system;

FIG. 52 shows a flow chart for the twirling process in the virtual hand model;

FIG. 53 illustrates a scene graph for the virtual assembly design environment when the fingers of a virtual hand are grasping a part;

FIG. 54 shows a graphical representation of finger motions for twirling a part; and

FIG. 55 illustrates an exemplary client computer system.

### DETAILED DESCRIPTION OF THE PREFERRED EMBODIMENT

The invention is directed to a method and system for a Virtual Assembly Design Environment (VAE) that enables users to evaluate, analyze, and plan the assembly/disassembly of parts for mechanical systems. The invention employs an immersive virtual reality (VR) environment that is tightly coupled to a computer aided design (CAD) system. The Invention includes: (1) data integration (two-way) with a parametric CAD system; (2) realistic 3D interaction of an avatar such as a virtual hand with virtual parts in the VR environment; (3) creation of valued design information in the VR environment; (4) reverse data transfer of the created design information from the VR environment to the CAD system; (5) significant interactivity in the VR environment between the virtual hand and virtual parts; (6) collision detection between virtual parts; and (7) physical world-based modeling of the interactivity between the virtual hand and the virtual parts.

The mechanical system of parts for an assembly is designed using a parametric 3D CAD system such as Pro/Engineer™. In one embodiment, a user selects an option in the CAD system that calls the VAE system to automatically export the data necessary to recreate 3D virtual parts in a virtual environment. Next, the user engages one or more VR peripheral devices to enter the virtual environment where the user is presented with a virtual assembly scene. The invention is capable of supporting a variety of virtual reality peripheral devices, e.g., a CYBERGLOVE by Virtual Technologies Inc. and a head mounted display. The various 3D virtual parts are initially located where they would be in a real assembly plant as defined by the user, which can then perform the assembly of the parts in the virtual environment.

In the virtual environment, the user can make decisions, design changes and perform a host of other engineering tasks. During this process, the virtual environment maintains a link with the CAD system and uses the capabilities of the CAD system wherever required as described in greater detail below. However, the operation of the virtual environment by the invention is not limited by the level of the interactivity with the CAD system. At the end of the VAE session, the user will have generated valued design information which is then automatically made available to the user in the CAD system.

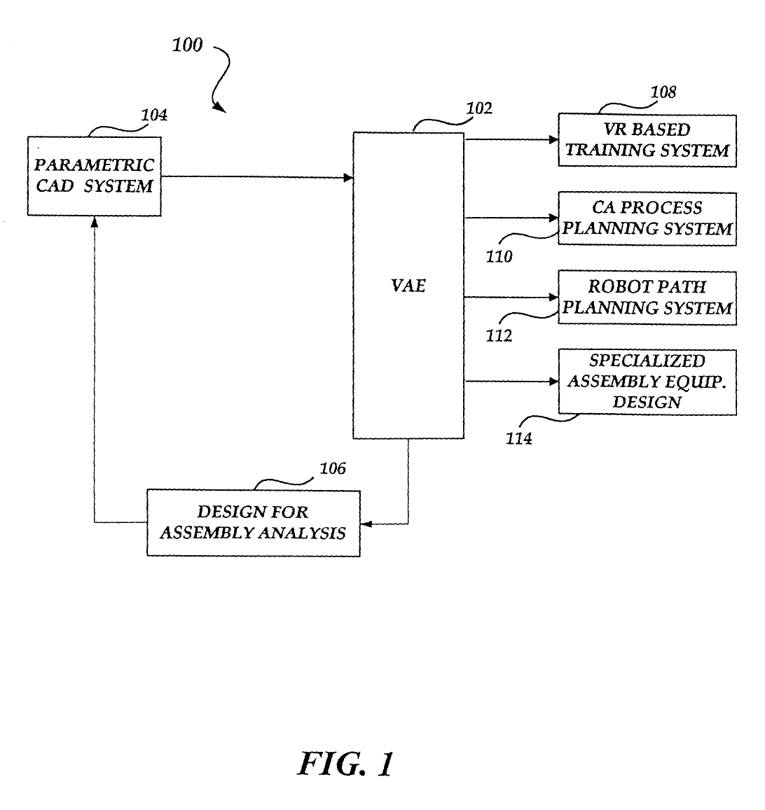

FIG. 1 shows an overview 100 of the interactions between a VAE system 102 and a parametric CAD system 104. In real time, the CAD system 104 provides part assembly geometry, tolerances and part attributes, e.g., center of mass and friction, to the VAE system 102, which outputs trajectory and sequence information collected in the virtual environment to another facility 106 for analysis. The outputted trajectory and sequence information is employed to analyze the design for assembling the parts to determine if changes in the design assembly should be made. The other facility 106 forwards the trajectory and sequence information to the CAD system 104 along with any suggested design changes for assembly. Optionally, the VAE system 102 can provide an interface to one or more other systems, including a VR based training system 108, a computer aided process planning system 110, a robot path planning system 112 and a specialized assembly equipment design 114.

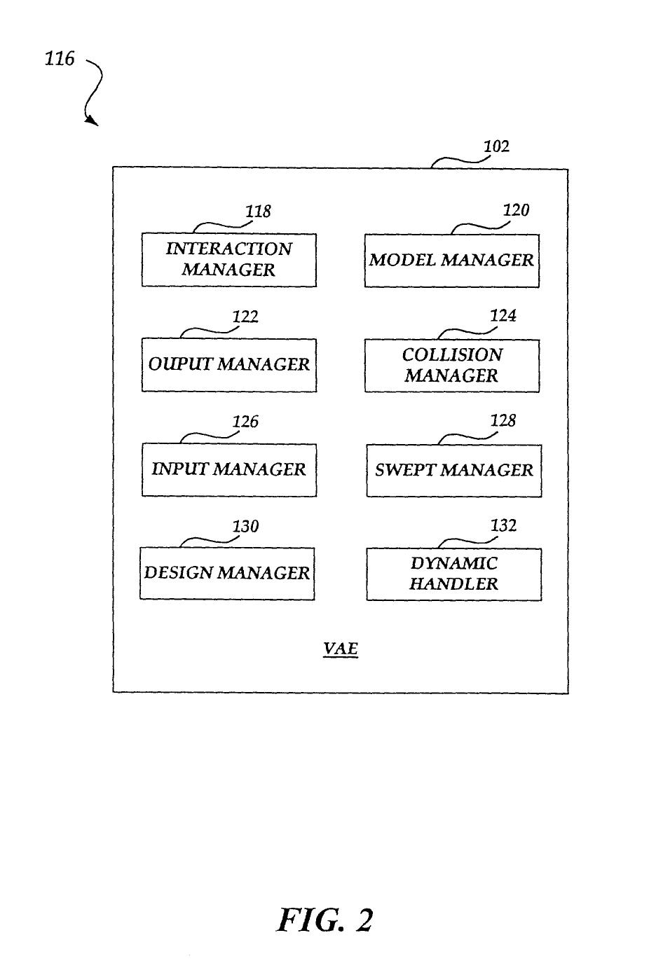

In FIG. 2, an overview 116 is shown of the architecture for organizing eight separate object oriented software modules in the VAE system 102. An Interaction Manager module 118 is employed to harmonize all of the modules and features of the VAE system 102; and a Model Manager module 120 is used to obtain assembly model and environment model information from the CAD system 104. Also, an Output Manager module 122 is employed to create and update a graphics display and manage a scene graph; and a Collision Manager module 124 is used to provide real-time collision detection. Additionally, an Input Manager module 126 is employed to obtain user input including tracking data, glove data and keyboard entries; and a Swept Manager module 128 is used to create and control the editing of swept volumes and part trajectories. A Design Manager module 130 is employed to enable a user to perform parametric design modifications in the virtual environment and integrate these design modifications with the CAD system 104; and a Dynamic Handler module 132 is used to simulate dynamic behavior for a part in the virtual environment.

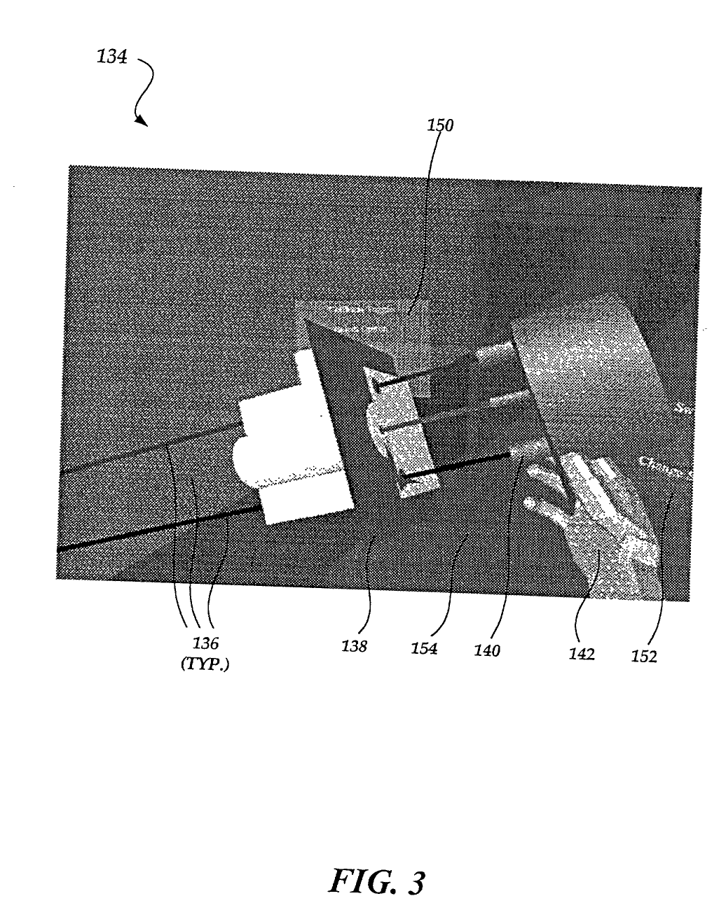

FIG. 3 illustrates a virtual scene 134 produced by the invention showing a constrained sliding motion for insertion of a virtual part 140 into a base assembly 138 along three determined axes 136. A user controlling a virtual hand 142 can select collision options in a virtual context menu 150 and swept volume generation options in another virtual context menu 152. A virtual workbench 154 is disposed in the virtual scene 134.

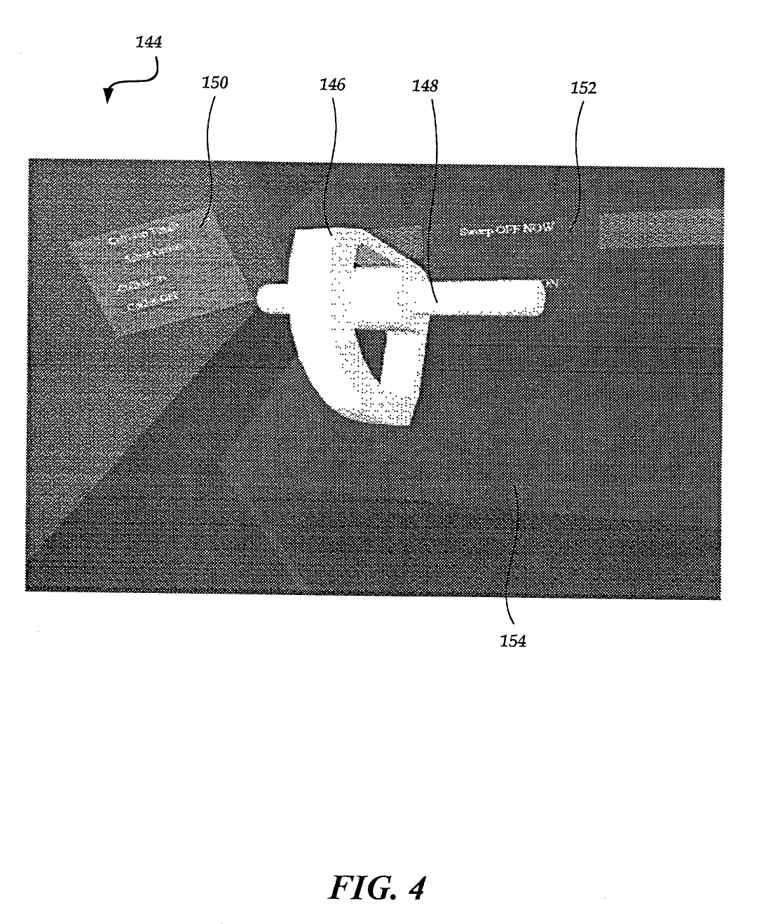

FIG. 4 illustrates a virtual scene 144 with a pendulum shaped virtual part 146 rotating about a fixed shaft virtual part 148 and translating along the axis of the virtual shaft. Disposed in the virtual scene 144 is the virtual context menu for selecting collision options in a virtual context menu 150 and the other virtual context menu 152 for selecting swept volume generation options. Also, the virtual workbench 154 is disposed in the virtual scene 144.

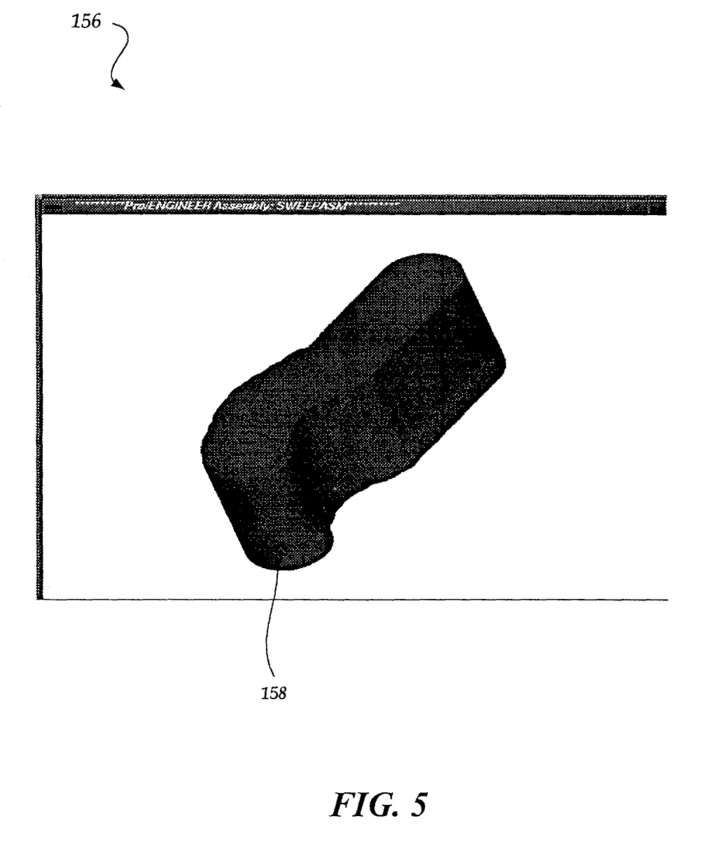

FIG. 5 illustrates a displayed screen 156 in a CAD system for a swept volume 158 that has a parametric representation and which was sent back to the CAD system for generation as a feature of the assembly.

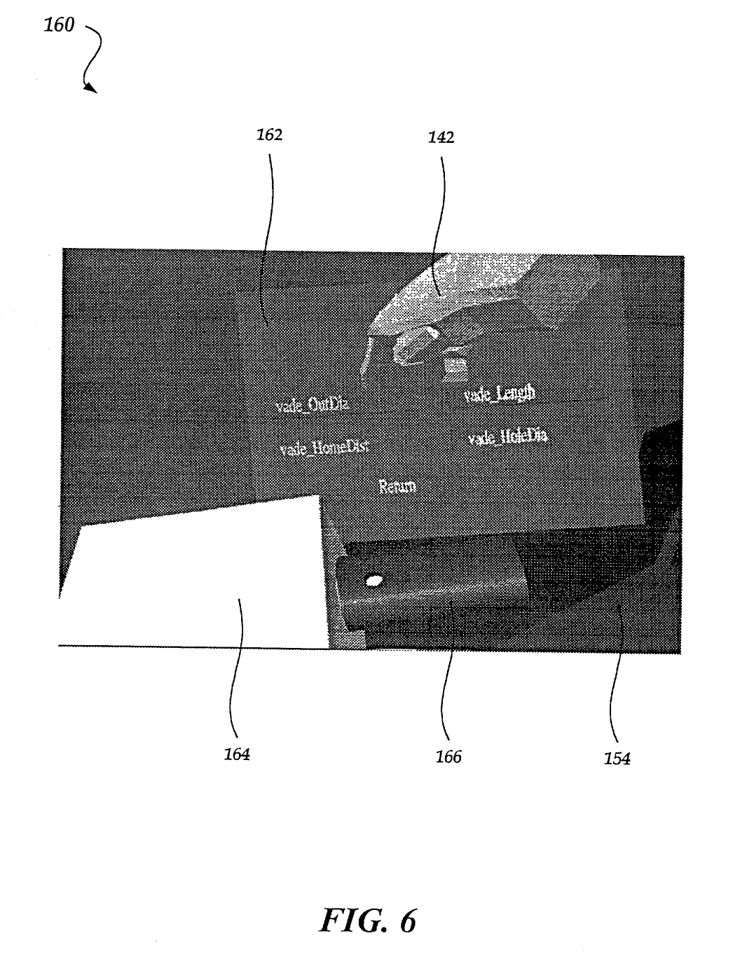

FIG. 6 illustrates a virtual scene 160 of the virtual hand 142 selecting parameter options in a virtual context menu 162 for a shaft virtual part 166 that is positioned in a base virtual part 164 and which is disposed on the virtual workbench 154.

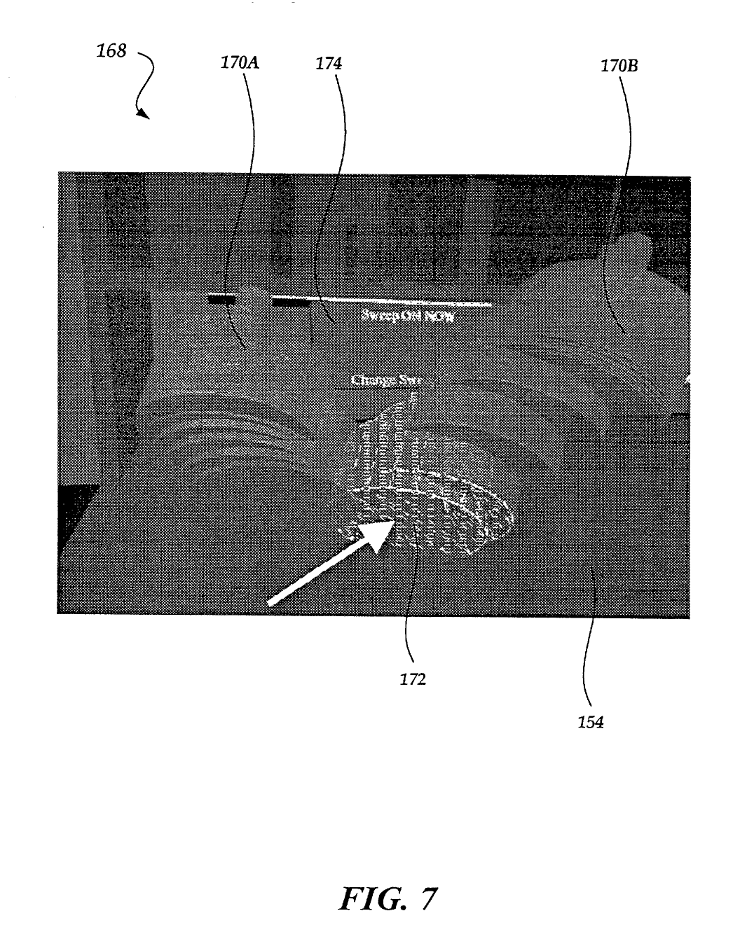

FIG. 7 illustrates a virtual scene 168 of a virtual part being moved along a trajectory path in the virtual environment when the swept volume and collision detection features are turned on. A beginning swept volume 170A and an end swept volume 170B for a virtual part are positioned at either end of the trajectory of the virtual part. In the trajectory path, exact instances of swept volume collisions 172 with the virtual workbench 154 are highlighted.

The invention can perform and/or assist a user in assembly design evaluation, analysis, and assembly sequence planning at all product realization stages: assembly plan verification (pre-product evaluation), maintenance verification, and alternative plan searching (post-production evaluation).

In the assembly plan verification stage, the Invention enables assembly to be performed in a pre-defined sequence. The user can assemble virtual parts one by one in the virtual environment using constrained motion, swept volume and collision detection. If there is any interference detected during the assembly process, the user can try to find a way to get around it in the virtual environment.

The maintenance verification stage enables the user to check disassembly of a particular part. If a part needs to be taken out of a larger assembly for maintenance, e.g. change a spark plug or an oil filter, the invention can be employed to ensure a clear trajectory path for disassembly. In one embodiment, the user removes a virtual part from its final position in a larger assembly of virtual parts and the invention checks for collision detection during the disassembly process. In another embodiment, a swept volume of the trajectory path is created during the disassembly process for a particular virtual part. This swept volume is checked for interference with other virtual parts in the larger assembly of virtual parts. By observing the disposition of the swept volume, the invention can determine how much space is available to perform a disassembly operation.

Sometimes it is necessary to find alternative plans or sequences for operations that are already being carried out in a workshop with real parts. It is also common to post-evaluate an assembly operation. Stopping the assembly line to perform the testing is not always economically feasible and often very few alternatives can be tried out in the limited time available. The invention provides a viable alternative where assembly experts can try various alternatives, choose the best one, suggest design changes, suggest fixturing changes and perform ergonomic evaluations of the assembly/disassembly process. The results of these evaluations in the VAE system can be automatically transferred back to the original CAD system so that a user can quickly perform design changes without any other data translation.

From the invention test data, several observations have been made: (1) Pure assembly time in a virtual environment is lower than actual assembly time (about 10-15%), which can be attributed to the lack of fastening operations in the virtual environment; (2) Pure assembly time for each virtual part in the assembly increases with the physical size of the part because the difficulty to handle a part appears to increase with its size; (3) Average gripping time for each part in the assembly remains almost the same for different sizes of parts and mainly depends on a user's practice and experience in the virtual environment, whereas gripping difficulty depends on the shape of the part (a thin, long shaft is more difficult to grab than a cubic block); and (4) When considering the relationship of pure assembly time and total assembly time, the correlation coefficient is low for large assembly (0.9 for small assembly, 0.98 for half size large assembly and 0.7 for large assembly), which indicates that human considerations start influencing the assembly time for larger models, e.g., moving some distance to grab the part, finding a better viewing position to look at the part and aligning the parts.

Besides quantitative information, the invention enables qualitative information to be obtained. For example, a full-size assembly in a virtual environment provides intuitive and valuable information that is impossible to obtain from conventional assembly modeling by a CAD system. The invention test data also illustrated other potential capabilities such as training, work space study and operation time study.

With the assistance of all the capabilities of the invention, a user can perform assembly design evaluation, maintenance verification, alternative assembly plan searching, and part design modification as described above. Also, since the invention involves the experience and actions of the user, the assembly plans generated by the invention automatically include input from the knowledge of experienced users.

Additionally, since the invention is typically presented in a full immersion mode using a head mounted display, it can be tiring to put the user in the environment for a long period of time. However, combining parts into sub-assemblies has been found to reduce the amount of time a user spends in the virtual environment.

Virtual assembly evaluation and planning is particularly suited for complex assembly operations that involve a person. Also, automatic assembly planning systems are well suited for assembly models with a large number of parts that require relatively simple assembly operations (involve translation and one axis rotation) which are often performed by robots. In some cases, a combination of virtual and automatic assembly evaluation can be the best solution. For example, the automatic assembly planning system could be used to find some feasible assembly process plans. Next, the user could then enter the virtual assembly environment (VAE) for evaluation, verification, consideration of practical problems related to the realization of the assembly design and optimization.

In the sections below, several aspects of the invention are explained in greater detail, including: (1) enhanced constrained motion simulation; (2) physically based modeling of a virtual environment; (3) generation of swept volumes and interactive swept volume trajectory editing; (4) parametric design modification; and (5) finger twirling.

### ENHANCED CONSTRAINED MOTION SIMULATION

From the CAD system, constraints are obtained and transferred to the VAE system. For axis constraints, two points in space defining the ends of the graphical line representing the axis are obtained. For plane constraints, three unit vectors and the origin defining the plane are obtained. One of the unit vectors is the normal vector for that plane, starting at the origin of the plane. In both cases, the type of constraint (align or mate) and the offset, if any, between the two axis or planes under consideration are also obtained.

Additionally, during the assembly process, the geometry representation of the constraints of the base part and the constraints of the part being assembled are transformed into the same coordinate system to check for closeness. If a constraint meets certain criteria, it is applied and the part's motion is limited to the constrained space. For example, if the part is constrained on an axis of the base part, the part can only slide along the axis and rotate about the axis. Alternatively, if the part is constrained on a plane of the base part, the part's motion is limited to the plane.

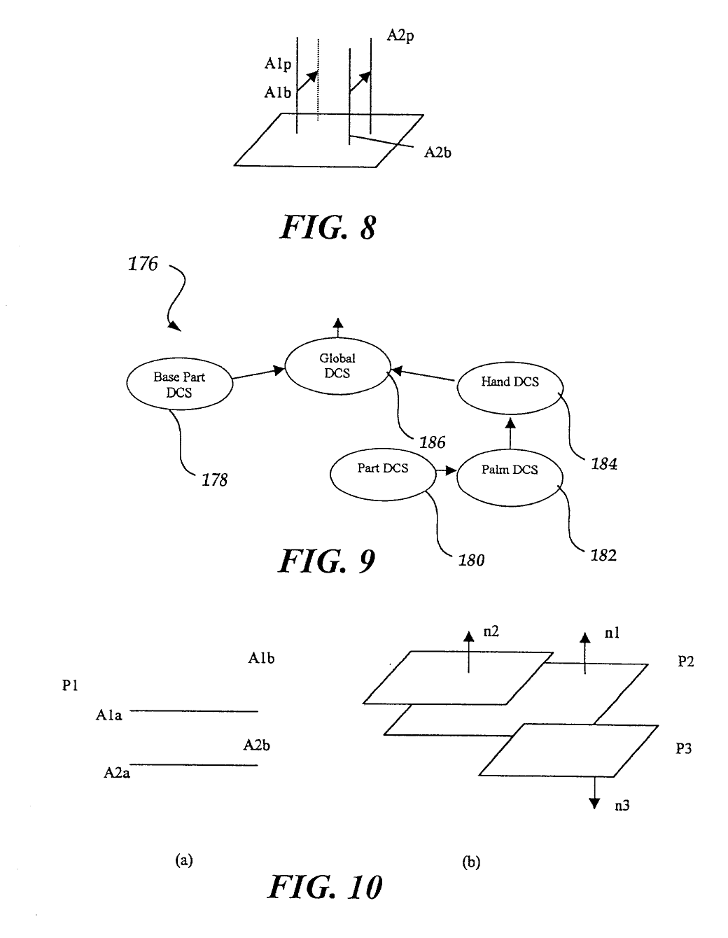

Although the above method can correctly map the physical constraints in the virtual environment, it only works for one constraint at a time. In some cases, using the above methods will result in the loss of previously applied constraints. For example, in FIG. 8, where two parallel axial constraints are to be applied and one has already been applied (axis A1). Simply snapping the constraint of axis A2 by translating the part will result in a loss of the previous constraint. A1b and A2b are two axes on the base part and A1p and A2p are two axes on the part. A1p and A1b have been snapped together. A simple snapping of A2b onto A2p will move A1b away from A1p, which destroys the previously applied constraint.

FIG. 9 illustrates a scene graph 176 used to represent the graphical data structure of the VAE system. The scene graph 176 provides an intuitive way to represent the hierarchical relationships between the objects in the virtual world usually the relationships between different dynamic coordinate systems (DCS). More importantly, it provides a way to edit and modify the relationships between the objects in the virtual world. For example, a part DCS 180 represents the coordinate system attached to a part, etc. A base part DCS 178 moves with a FOB bird in the user's left hand so base part DCS 178 is directly under a global DCS 186. The grabbed part can be manipulated in the user's right hand using a CYBERGLOVE. The part's location and orientation is calculated through its relationship with the palm and a FOB bird attached on the user's right-hand wrist, so that a part DCS 180 is attached to a palm DCS 182, then to a hand DCS 184 before it goes to the global DCS 186.

Referring to the scene graph in FIG. 9, the following equation is used to transform the geometry from the part DCS 180 to the global DCS 186. The [partLocationXform] is the transformation from the part DCS 180 to the global DCS 186, the [part_matrix] is the transformation matrix from part DCS 180 to palm DCS 182, the [palm_matrix] is the transformation from palm DCS 182 to hand DCS 184, and the [hand_matrix] is the transformation from the hand DCS 184 to the global DCS 186. The [baseLocationXform] transforms geometry from base part to the global coordinate system.

[partLocationXform]=[part_{—}matrix]×[palm_{—}matrix]×[hand matrix] (1a)

(geometry of part in global)=(geometry of part)×[partLocationXform] (1b)

(geometry of base in global)=(geometry of base)×[baseLocationXform] (1c)

Then, in the global coordinate system, the geometry pairs of axis or plane constraints are compared to check for align or mate status. If certain tolerance values are satisfied, they are said to be constrained and equation (2) is used to apply the axis constraint.

[part_{—}matrix]=[sv_{—}NegXform]×[axisRotate]×[partTranslationXform] (2)

Where [sv_NegXform] takes the part's axis to the origin of the part. Next [axisRotate] makes sure that the two axis under consideration are parallel. Finally [partTranslationXform] snaps the part's axis on to the base part's axis so that they are aligned and constrained. After the axial constraint is applied, the allowable motions are along that axis and about the axis.

[part_{—}matrix]=[p_{—}originNegXform]×[normalRotate]×[p_{—}originXform]×[distance_{—}bp_{—}normalXform] (3)

Equation (3) is used to apply the plane constraint where [p_originNegXform] moves the origin of the plane on the part to the origin of the part coordinate system, [normalRotate] makes sure the two planes are parallel. Then [p_originXform] takes the origin of the part plane back to its original position. Finally [distance_bp_normalXform] snaps and constrains the two planes together by moving the part plane in the required direction.

In axis and plane constraints, there is axis align (inserting), plane or surface align, and plane or surface mate, as shown in FIG. 10. In section (a) of FIG. 10, axis A1 (with end points A1a and A1b) is going to be aligned to A2 (with end points A2a and A2b). Also, in section (b) of FIG. 10, P1 (with normal n1) is aligned with P2 (with normal n2) and is mated with P3 (with normal n3).

When checking the align or mate status, differentiating them can be complex especially for plane constraints. However, the plane normals on the part and the base part are in the same direction if they are aligned. An inaccurate way to differentiate is to check that the dot product of n1 and n2 is near +1 if they are required to be aligned and −1 if they are required to be mated. A more accurate method for getting the constraint information from the CAD system is shown in FIG. 11, which illustrates axis (with two end points, Aa, Ab) and plane (with an point Ori, three vectors e1, e2, and e3) constraints.

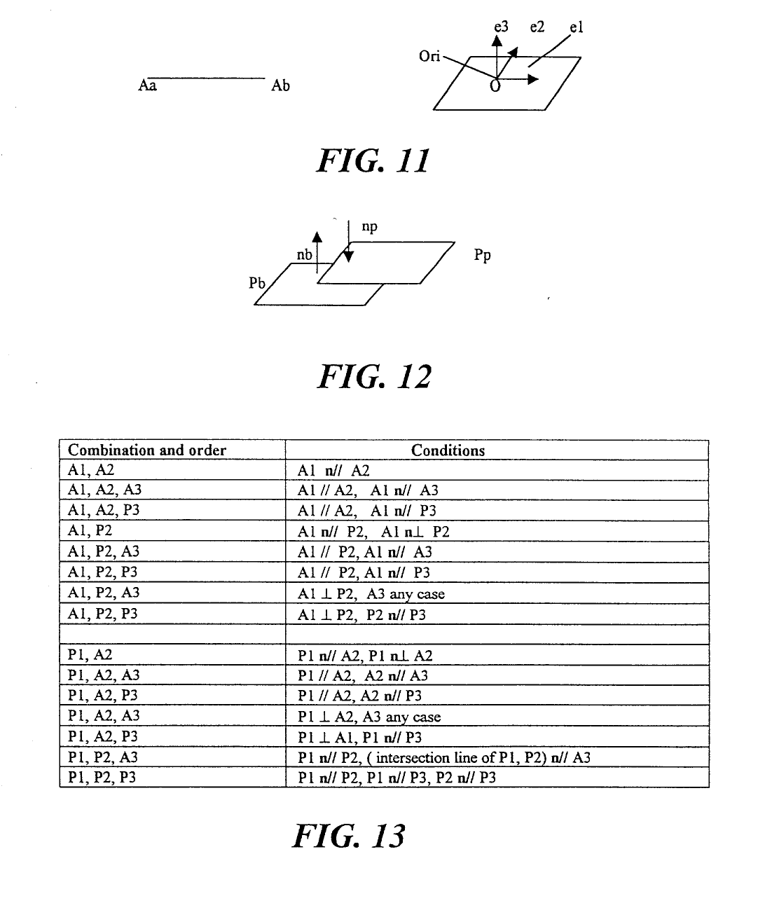

From the CAD system, for a plane constraint, a point, Ori, is obtained as the origin of the plane, as well as three unit vectors that are mutually perpendicular to each other. The information is in the part coordinate system. The corresponding information on the base part is obtained by the final transformation (the transformation matrix when the part is finally assembled onto the base part) between them. This is shown in FIG. 12 where the plane on part (Pp) is mated with plane on the base part (Pb). In FIG. 12, Pp is a plane on the part (with normal np), Pb is a plane on the base part (with normal nb). And nb is calculated by Equation-4.

nb=np×[TransformMat] (4)

In the equation (4), [TransformMat] is the transformation matrix between the part and the base part when the part is assembled to it's final location. The normal on the base part is defined in base part DCS, while the normal on the part is defined in part DCS. However, when the normal vectors need to be checked, they need to be checked in the same coordinate system. When checking the constraints in the part DCS, transform nb is transformed from base part DCS to part DCS using equation-5 (nb^{p} is the representation of nb in part DCS). In the equation, [baseInPartXform] is the transformation from base part DCS to part DCS. If the part is in its final location, [baseInPartXform] is equal to [TransformMat]⁻¹. So there is nbp=np.

nb in part DCS=nb×[baseInPartXform]=nb^{p} (5)

The normal vectors look opposite to each other, however, that is because they are viewed in different coordinate systems. For example, if a point is transformed to get a point in another coordinate system, when it is transformed back, it is still the same point, therefore, if viewed in the same coordinate system, e.g. in the part coordinate system, the two normal vectors are exactly the same.

Therefore, when align status of two axes or two planes is checked, the dot product of the two axis vectors or two normal vectors are checked to be near +1. When the plane mate status is checked, the dot product of the two normals is also checked to be near +1. No −1 should be involved at all.

Another useful observation can be made from the above discussion: since the constraints on the base part are defined by the constraints on the part, the constraints on the part can be defined in an arbitrary way without affecting the final location of the part when it is assembled on to the base part. Therefore, some complicated or abstract types of constraints can be replaced with simple types of constraints. For example, a coordinate system constraint can be replaced with three axis constraints. This step simplifies the simulation task in some cases.

Axis and plane (or surface) constraints are the most frequently used constraints in assembly operations to fix a part on a base part or a subassembly. In CAD systems, the user is allowed to pick any number of axis or plane constraints as long as they are not in conflict with each other. This, however, gives rise to some redundant information in the assembly operation. In CAD systems, the final position of the part is important, the order is not. However, in real and virtual assembly, the ordering of parts does matter. By analyzing all of the possible combinations of axis and plane constraints, invention can determine which set of axis and plane constraints are enough and which are redundant.

An exemplary result is listed in a table in FIG. 13. “A” is denoted as axis constraint and “P” as plane constraint. Also, numbers are employed to represent the order of the constraint. For example, “A1” means the first one applied is an axis, “P2” means the second one is a plane constraint, etc. In FIG. 13, all of the possible combinations that can completely constrain the motion of a part on the base part are listed. In the table, a symbol of “⊥” represents perpendicular, “//” represents parallel, “n⊥” represents not perpendicular, and “n//” means not parallel. The first column shows the various possible ways in which up to 3 constraints (axis or plane) can be used in a specific sequence to fully constrain the motion of a part. The second column shows the conditions under which a specific sequence of constraints can fully constrain a part.

Careful observation of FIG. 13 leads to the three following conclusions. First, three non-redundant axis or planar constraints are sufficient to fully constrain a part. The user should not choose more than three axis or plane constraints in the assembly design. This conclusion is very useful and means that when the third constraint is applied, the part will be completely constrained. So, in constrained motion mapping, the invention maintains the first applied constraint when the second one is applied. The task of maintaining the previous constraints is greatly simplified: the invention applies the first one using the snapping method, then uses the snapping method or the methods described in the next section to apply the second one, and when the third one is to be applied, it has reached the final location and the part is placed.

Second, if two parallel axes are used, any third axis parallel to one of them is redundant. Further more, any plane parallel to them is also redundant.

Third, if a plane is used, any other plane parallel to it is redundant. If a plane and an axis parallel to it are applied, any axis parallel to the plane or the previous axis is redundant, and any plane parallel to the plane is redundant. If two planes are used, any axis parallel to the intersection line of the two planes is redundant.

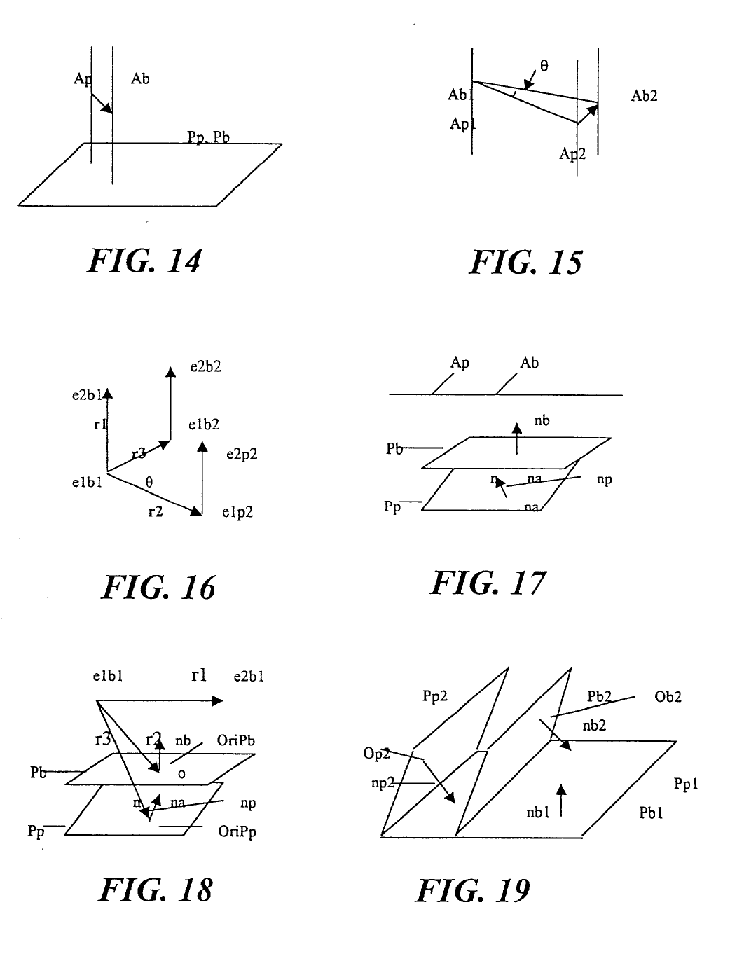

From the three conclusions discussed above, it is understood that at most three constraints are needed to fix the part and only the first one needs to be maintained. In some situations, just using equations (2) and (3) will do the work. For example, FIG. 14 illustrates when P1 is applied (a plane on part Pp is snapped with a plane on base part, Pb), the snapping of the part onto A2 (snap an axis on part Ap onto an axis on the base part Ab) will not violate the previously applied planar constraint. From the analysis of all the situations in FIG. 13, there are at least three cases that will need special treatment.

Case 1: An axis constraint has been applied (Ap1 and Ab1), another axis constraint (Ap2 and Ab2), which is parallel to the first one, is going to be applied. FIG. 15 illustrates Case 1 with an axis on part (Ap1) and an axis on base (Ab1) that have been snapped together. Another axis on part (Ap2) needs to be snapped to its corresponding axis (Ab2) and a simple snapping method will move Ab out from Ap.

In this case, the snapping method is used to snap Ap1 to Ab1 by equation (2). Equation (1) is still used to calculate and check the align status for Ap2 and Ab2. If the condition is satisfied, the invention calculates the angle θ.

As shown in FIG. 16, e1b1 and e2b1 are the end point of axis 1 on the base part; e1b2 and e2b2 are the end points of axis 2 on the base part; and e1p2 and e2p2 are the end points of axis 2 on the part. Let vector r1=e2b1−e1b1, vector r2 =e1p2−e1b1 and vector r3=e1b2−e1b1. First r1 r2, r3 are normalized; then angle θ is calculated as

θ=cos⁻¹(((r1×(r2×r1))•(r1×(r3×r1))) (6)

where “x” denotes cross product and “•” denotes dot product.

The transformation matrix is calculated for rotating the part about axis Ab by angle θ, [rotate_matrix_Ab_axis]. The final transformation of the part in the PalmDCS will be

[part_{—}matrix]=[part_{—}matrix_{—}A1]×[rotate_{—}matrix_{—}Ab_{—}axis] (7)

where [part_matrix_A1] is the part matrix calculated by using equation (2) when the first axis is applied. Also notice that Ab1 does not necessarily pass through the origin of the part DCS.

Case 2: An axis constraint has been applied, the second one is a plane, which is parallel to the applied axis. As shown in FIG. 17, an axis on part (Ap) and an axis on base part (Ab) have been snapped together. A plane on part (Pp) needs to be snapped to a plane on base part (Pb) and a simple snapping method will move Ap away from Ab.

In the second case, the invention also uses the snapping method to snap Ap to Ab by equation (2). Equation (1) is still used to check the align status Pp and Pb. If the condition is satisfied, a transform matrix is formed by rotating about Ab by an angle. The angle is calculated as shown in FIG. 18. In this figure, e1b1 and e2b1 are the end points of the first applied axis, OriPp and OriPb are the origins of the planes on the part and the base part, Let vector r1=e2b1−e1b1, vector r2=OriPp−e1b1 and vector r3=OriPb−e1b1, First r1 r2, r3 are normalized. The angle of rotation is calculated as:

θ=cos⁻¹(((r1×(r2×r1))•(r1×(r3×r1))) (8)

The final transform of the part in the PalmDCS will be

[part_{—}matrix]=[part_{—}matrix_{—}A1]×[rotate_{—}matrix_{—}Ab_{—}plane] (9)

where [part_matrix_A1] is the part_matrix calculated by using equation (2) when the first axis is applied. Similarly notice that Ab does not necessarily pass through the origin of the part DCS.

Case 3: A plane constraint has been applied, the next one is a plane which is not perpendicular to the first one. If the second one is perpendicular to the first one, a simple snapping method can be used.

FIG. 19 illustrates Case 3 where a plane on part (Pp1) and a plane on base (Pb1) have been snapped together. Another plane on part (Pp2) needs to be snapped onto another plane on base (Pb2). A simple snapping will move Pp1 out of Pb1.

In Case 3, the snapping method is used to snap Pp1 to Pb1 by equation (3). Equation (1) is used to check the align status. If the condition is satisfied, [p_orginNegXform] and [p_originXform] are calculated so that Pp2 can be oriented parallel to Pb2. Now the task is to figure out a transformation vector that is parallel to Pb1 and perpendicular to the intersection line of Pb1 and Pb2.

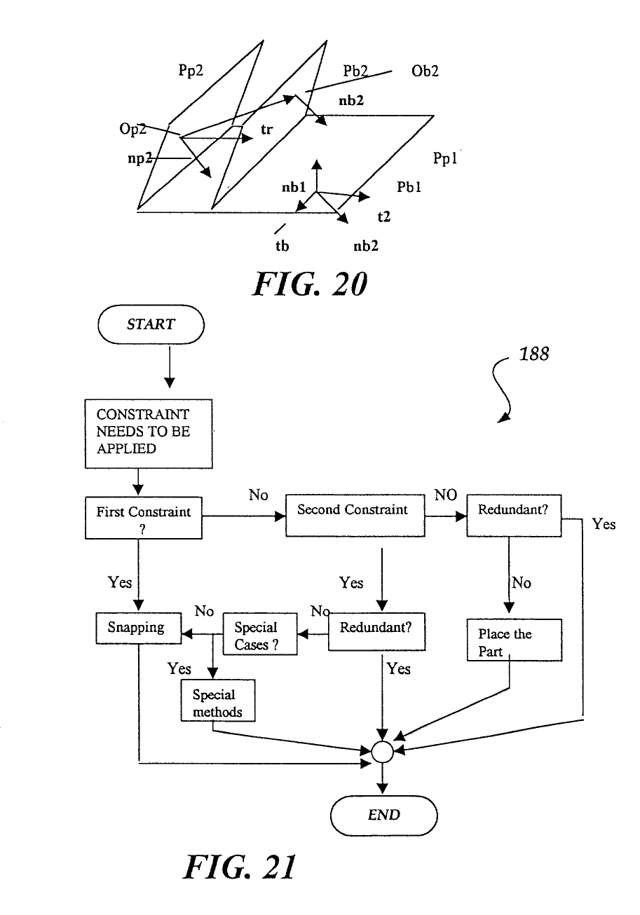

The vector translation of Case 3 is shown in FIG. 20, where the invention calculates the intersection vector of the two planes by the cross product of the normals of the two planes on the base part, i.e.

tb=nb2×nb1 (10)

next, the invention calculates the translation direction vector t2

t2=nb1×tb (11)

t2 is normalized to obtain the translation vector

tr=((Ob2−Op2)•t2)t2 (12)

The vector tr is the translation vector used to form a translation matrix [translation_along_plane], putting the above calculations together

[part_{—}matrix]=[part_{—}matrix_{—}P1]×[p_{—}originNegXform]×[normal_{—}rotate]×[p_{—}originXform]×[translation_{—}along_{—}plane] (13)

where [part_matrix_P1] is the part_matrix calculated by using equation (3) when the first plane constraint is applied.

The three special cases described above are situations where special methods are needed for accuracy. In other situations, the simple snapping method can be used.

With the help of above conclusions and methods, the invention can simulate the constraints during the assembly process. The redundant constraints are processed during the constraint checking process. A work flow chart 188 is shown in FIG. 21 for processing and application of multiple constraints. In this figure, special cases and special methods refer to the cases and methods discussed above.

In one embodiment, global position and orientation tracking is done by the Ascension Flock of Birds™ system with an Extended Range Transmitter (ERT). This transmitter employs a pulsed, DC magnetic field and is capable of determining 6 DOF information from each of its receivers. Three receivers are used in this system, one to track the head so that the user can ‘look around’, another to track the right hand and the last one is held in the left hand facilitating assembly operations.

In one embodiment, the CYBERGLOVE is used to monitor the finger and wrist movements of a user. This 22 sensor glove augments the graphical representation of the right hand in the VAE system. It measures the motions of the wrist joint, the bending of the three joints on all four fingers and the thumb, the abduction between all four fingers, the arch of the palm, and the abduction of the thumb from the palm. The digitized output values from the glove sensors are converted to appropriate joint angles for a specific user's hand using a calibration routine. These joint angles are compared against a glove tolerance to facilitate releasing the part when the user stretches his/her hand to drop the part.

In one embodiment, the graphical basis for the invention is created with a Silicon Graphics IRIS Performer™ Library. IRIS Performer™ is a software toolkit for the development of real-time 3D graphics, visualization, and simulation applications. Performer™ sits “on top” of Silicon Graphics OpenGL™ libraries. It also has better optimization of its own functions and in turn allowed better performance when using complex models.

Pro/ENGINEER™ can be used for the creation of the CAD models for use in the invention. Also, Pro/DEVELOP™ is a developer's toolkit for Pro/ENGINEER™, which is designed to be used as a means to access the Pro/ENGINEER™ database. The Pro/DEVELOP™ module automates and simplifies data exchange between the CAD system and the VAE system.

### CONSTRAINT MANAGEMENT

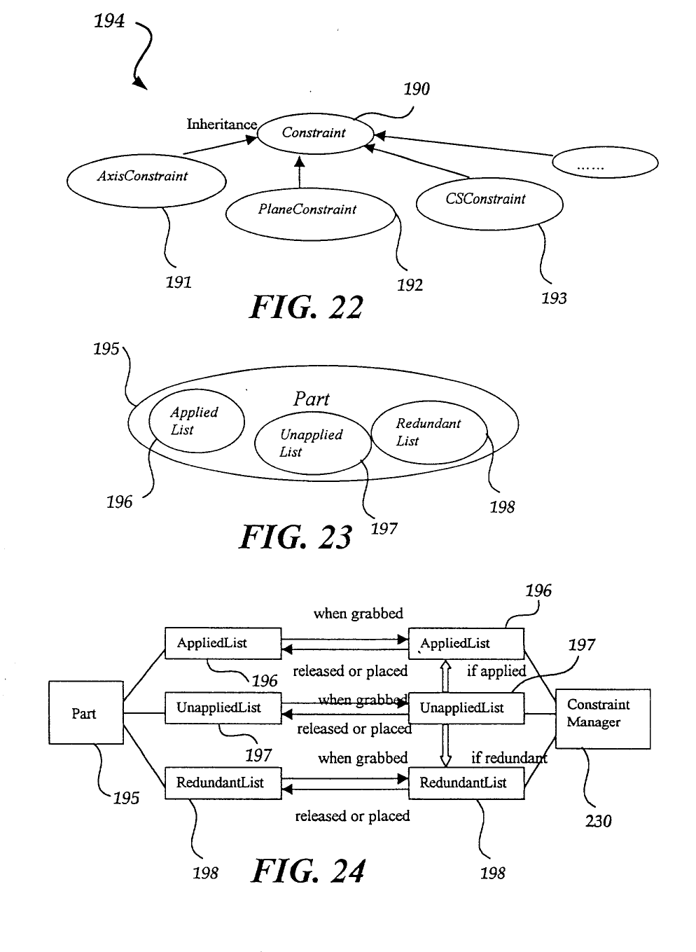

Object-oriented methods are used to abstract and represent the constraints in the invention. Humans learn about objects by studying their attributes and observing their behaviors. Object-oriented programming models real-world objects with software counterparts. Using object-oriented technologies, the invention can take advantage of object relationships where objects of a certain class have the same characteristics i.e. inheritance. Considering the constraints used in the virtual assembly processes, even though the representations of the constraints are different, they all share the same behaviors: a checking process and an application process. This becomes a typical inheritance situation. According to the analysis and abstraction of real world constraints, The invention employs a Constraint class 190 and by inheritance includes other specific constraint classes, e.g. an AxisConstraint 191, a CSConstraint 193 and a PlaneConstraint 192 which FIG. 22 shows in an overview 194. Thus, a part maintains a list of “constraints” without needing to know the detailed nature of the constraint. In the Constraint class two virtual functions are defined, checkConstraint and applyConstraint. In the children classes, there are defined the geometrical representations according to the type of the constraint and override checkConstraint and applyConstraint according to algorithms presented in the previous chapter.

In FIG. 21, the assembly process is shown to be a constraint application process. The degrees of freedom of a part relative to the base part are gradually reduced as the constraints are applied. So the constraints of a part have two different states: already applied or going to be applied. However, some constraints are redundant and will never be used at all. To catch this physical meaning, for a part 195, the invention employs three linked lists of constraints named AppliedList 196, UnappliedList 197 and RedundantList 198 as shown in FIG. 23. If the part 195 is not constrained and can move in the global space freely, all the constraints will be kept in the UnappliedList 197. If a constraint is applied, it will be moved from the UnappliedList 197 to the AppliedList 196. During the assembly process, if any one of the constraints is found to be redundant, it will be moved from the UnappliedList 197 to the RedundantList 198. After the part is fully constrained and placed on the base part, the UnappliedList 197 should be empty (if not empty, the remaining elements must be redundant and will be moved to the RedundantList 198). So finally in AppliedList 196, there is the sequence of constraint application and in the RedundantList 198, there is the redundant information from the design model. The information in these linked lists provides the information on the status of the part: floating, partially constrained, or placed. In addition, the lists provide information on the assembly sequence.

A ConstraintManager class 230 can manage the constraints for different parts. In the ConstraintManager 230 the invention defines three linked lists of the Constraint objects to hold the constraint status and data of the part that is being manipulated. The lists in the ConstraintManager 230 provide temporary processing and swapping space for constraint checking and application.

The constraint information exchanging between the ConstraintManager 230 and one part 195 is shown in FIG. 24. When the user grabs a part, the constraints in the AppliedList 196, the UnappliedList 197 and the RedundantList 198 of the part 195 are handed over to their corresponding lists in the ConstraintManager 230 for handling. If the part 150 is constrained by one or more constraints, the constraints will be moved from the UnappliedList 197 to the AppliedList 196. If the constraint is redundant, it will be moved from the UnappliedList 197 to the RedundantList 198. When the part 195 is released, the ConstraintManager 230 returns the lists back to their corresponding lists in the part 195. Also, when the part 195 is placed, the ConstraintManager will give a NULL value to the UnappliedList 197 in the part 195.

As discussed above, the graphical structure of the system is represented by the scene graph shown in FIG. 9. The part is attached to the palm DCS 182, which is attached to the hand DCS 184, which is attached to the global DCS 186. The location of the part in the global space is represented by equation (2.1).

[partLocationXform]=[part_{—}matrix]×[palm_{—}matrix]×[hand_{—}matrix] (2.1)

In the equation, [partLocationXform] is the transformation from the part DCS 180 to the global DCS 186, [part_matrix] is the transformation matrix from the part DCS 180 to the palm DCS 182, [palm_matrix] is the transformation from the palm DCS 182 to the hand DCS 184, [hand_matrix] is the transformation from the hand DCS 84 to the global DCS 186. In the meantime, [baseLocationXform] represents the transformation from the base DCS 178 to the global DCS 186.

If, at some time, the user releases the part while the part is constrained, the invention wants the part to stay on the base part and move with the base part. The relative location of the part to the base part at the time of release can be calculated by equation (2.2).

[partInBaseXform]=[part_{—}matrix]×[palm_{—}matrix]×[hand_{—}matrix]×[baseLocationXform]⁻¹ (2.2)

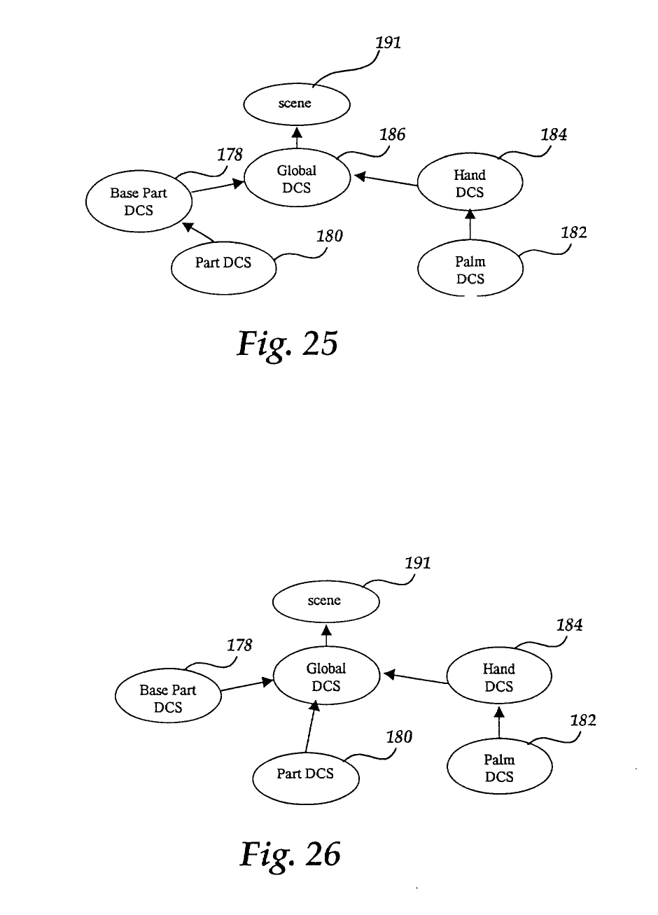

At the same time, the initial scene graph is changed by moving the part DCS 180 to attached to the base DCS 178 as shown in FIG. 25. In this case, the base DCS is under the global DCS 186 which provides the dynamic coordinate system for the virtual environment scene 191. The palm DCS 182 is attached to the hand DCS 184 which is under the global DCS 186. Constraint handling is performed according to FIG. 24. The constraints that have been applied are stored in the AppliedList 196 of the part 195.

When the user releases the part in his/her hands, if none of the constraints have been applied, the part DCS 180 will move under the global space DCS 180 where it is released, as shown in FIG. 26. When the user later comes to re-grab this part, the system needs to know where the part is: in the global space or attached to the base part. The handling method will be different since there is also a computation of the relative location of the part to the hand.

The problem finding where the part is attached becomes easy by noticing the difference between the two situations: if the part is constrained before it is released, the AppliedList 196 is not empty. If the part is not constrained when it is released, the AppliedList 196 is empty. So whenever a part is grabbed, a check is performed whether the AppliedList 196 is empty or not. If the AppliedList 196 is not empty, then that part is attached on the base part. Equation 2.3 is used to compute the relative location of the part to the palm to find out the gripping matrix. If the AppliedList 196 is empty, then the part is in the global space as in FIG. 26 and equation (2.4) is used to find the gripping matrix.

[partToPalmXform]=[partInBaseXform]×[baseLocationXform]×[hand_{—}matrix]⁻¹×[palm_{—}matrix]⁻¹ (2.3)

[partToPalmXform]=[part_{—}GlobalXform]×[hand_{—}matrix]⁻¹×[palm_{—}matrix]⁻¹ (2.4)

After re-grabbing, the scene graph goes back to FIG. 9.

Mechanical system assembly designs consist of many parts. During the assembly process, the parts can be in various stages in the environment: maybe only one axis constraint is applied, maybe only one plane constraint is applied, or maybe two axis constraints are applied, or maybe the part just lies on the table. So the constraint status of different parts are different. When the user grabs a part, the invention knows the status of the constraint information of that part: which one has been applied; the location of the part relative to the base part, etc. When the part is released from the user's hand, the invention remembers the current constraint status at that time. When several parts are involved, the invention keeps track of the constraint linked lists in every part 195 by data exchange between the ConstraintManager 230 and the parts 195 .

Additionally, there are bi-directional relationships between the parts 195 and the ConstraintManager 230. When the part 195 is released during the assembly, the ConstraintManager 230 returns all of the constraint lists to that part so that the ConstraintManager 230 can handle other parts. In this way, the invention ensures that the constraints of different parts are kept separate and the status of constrained motion of any part is maintained.

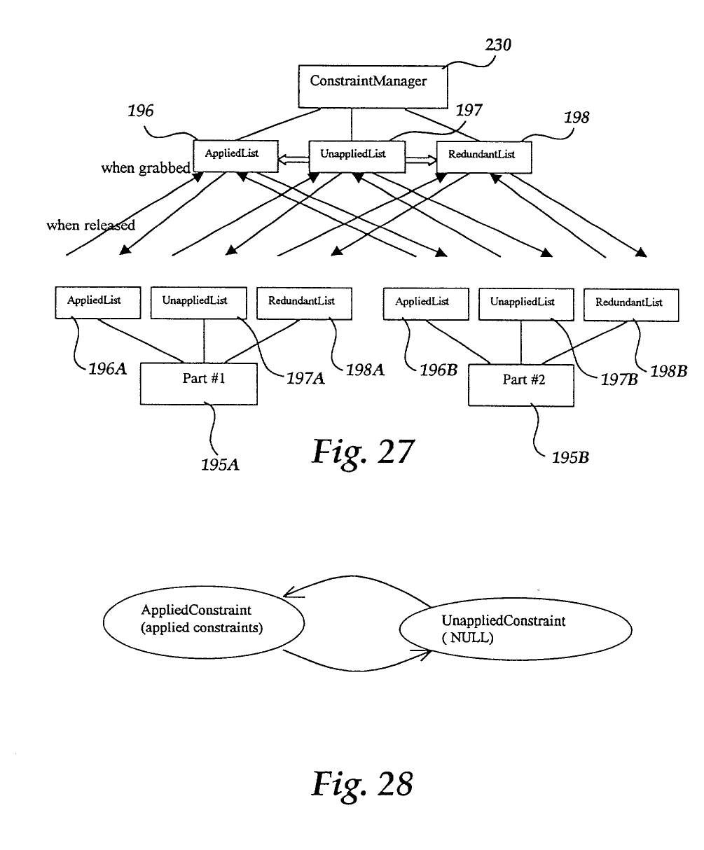

In FIG. 27, a schematic overview for the ConstraintManager 230 handling two parts (195A and 195B) is shown. In this figure, all of the arrows pointing up refer to a “when grabbed” status and all of the arrows pointing down refer to a “when released” status.

In the assembly process, the user may want to reassemble a part even after it is placed on to the base part already. The user perhaps wants to try out some other sequences, or he/she may want to assemble the part after some other parts have been assembled. The invention also provides the functionality for disassembly of assembled parts.

When the invention performs disassembly, the constraints in the part need to be rearranged. When the part is placed, the applied constraints are stored in the AppliedList 196 in the order that they are applied, the redundant constraints are in the RedundantList 198 and the UnappliedList 197 is empty. The invention moves/swaps all of the constraints in the AppliedList 196 to the UnappliedList 197, as shown in FIG. 28. The constraints in the RedundantList 198, however, need not be moved to the UnappliedList 197 since these constraints are filtered out during the assembly process and will are not used again.

When the user tries to grab the part out from the base part, the invention finds out where the part is. As discussed above, the invention can use the AppliedList 196 since the list is not empty after the part is placed. The main difference between a constrained part and a placed part is the transformation matrix that is used. In the former situation, the matrix is calculated when the part is released, i.e. [partInBaseXform]. In the later situation, the matrix is the final location matrix stored in the Part object (from the original data from CAD system). The transformation matrix of the part DCS 180 to the palm DCS 182 is calculated by equation (2.5).

[partToPalmXform]=[finalLocationMatrix]×[baseLocationXform]×[hand_{—}matrix]⁻¹×[palm_{—}matrix]⁻¹ (2.5)

Another problem in disassembly is that when the user grabs the part, the system will begin checking the constraints. Since all the constraints are close to their counterpart ones in the base part when the part is in the close vicinity of its final location, the part may be constrained right after the user grabs the part. This may not be what the user wants to do. To solve this problem, the invention sets a time lag for checking for constraints if the user wants to do disassembly. The invention begins checking constraints five seconds after the user disassembles the part.

If multiple parts are involved, especially when a new assembly model is loaded in to the environment, the user may not know how to assemble it. Just letting the user try the possibilities makes the system unfriendly.

It is desirable to have a guiding mechanism in the system that can provide assembly instructions to assist the assembly. The instructions should be simple, intuitive and easy to follow. First, the user needs to know where a part needs to go onto the base part when he/she picks up the part, then he/she needs to be given instructions of how to assemble the part step by step. Since the user may release the part during the assembly process, the system needs to remember the current constrained status of the part. When the user re-grabs the part, the system needs to provide hints on the next step operation based on the constrained status. Further, if the user wants to do disassembly, the system needs to remember the sequence of the previous operation and pass the information to the user to remind him/her of the previous operation sequence.

To fulfil the requirements listed above, constraint displaying functionality is provided. The geometry of the constraints are displayed when the user grabs the part: for axis, a line is displayed; for planes, a rectangle near the contact is displayed. When several constraints are involved, different colors are used. This gives the user a very intuitive feel for the assembly process. Further more, the constraints are displayed according to the status of the constraints. If one axis constraint is applied and the user lets the part follow the base part, next time when the user grabs the part again, the applied axis will not be displayed. If a redundant constraint is detected, it will not be displayed anymore. When the part is taken away from the base part, the next time when the user wants to reassemble it, all the constraints come back again except the redundant ones.

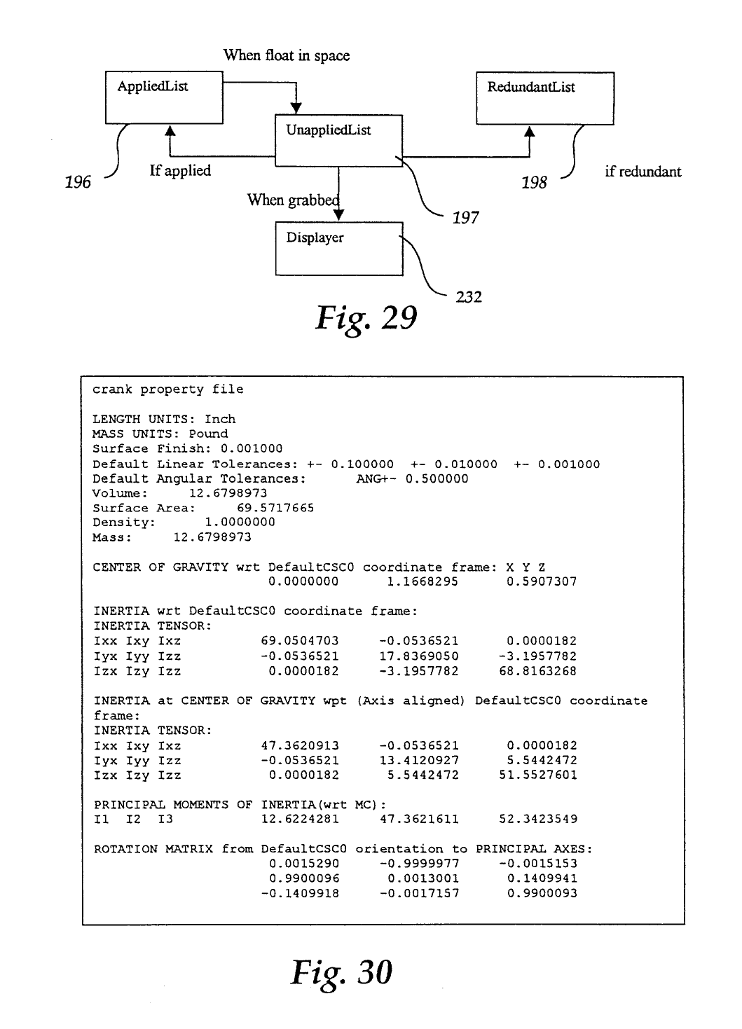

Although the requirements of the guiding mechanism are complicated, the task is not that complex because the invention recalls the information stored in the constraint lists. The method of handling this task is to make use of the constraint lists, the AppliedList 196, the Unappliedlist 197 and the RedundantList 198. Whenever the invention employs a displayer 232 to display the constraints, it starts with the UnappliedList 197. This ensures that only the unapplied constraints are displayed. The number of constraints displayed is reduced as the part is being assembled, which means that the allowed degrees of freedom reduces. Also, since the invention processes the redundant constraints all the time, if the constraint is moved to the RedundantList 198, the invention will not get it later, so gradually only the valid constraints are displayed even if the user starts all over. An overview of the guiding mechanism discussed above is shown in FIG. 29.

A detailed scenario is presented above for managing constraints in the virtual assembly environment. The system can efficiently manipulate multiple parts for assembly evaluations. When several constraints need to be applied, all of the constraints are applied in conjunction with the previous ones. When multiple parts are involved, each part moves observing its own constraint set.

### PHYSICAL BASED MODELING

The scene graph method provides an intuitive way to represent the hierarchical relationships between the objects in the virtual world (usually the relationships between different dynamic coordinate systems). More importantly, it provides a way to edit and modify the relationships between the objects in the virtual world.

One important feature of the invention is constrained motion simulation. The constraint information is extracted from CAD system and each independent constraint satisfied will reduce the number of allowable movements of the objects relative to each other. The invention can simulate axial and planar constraints during assembly design process in any kinds of order and combination. The invention employs methods that can simulate physical constraints commonly used in assembly design without using computationally expensive collision detection.

In physically based modeling, the basic equations of motion for rigid bodies used to set up the simulation model are the Newton-Euler's equations, which are as follows:

F=M V′ and N=dL/dt=Iω′+ω×L

Where F is the external force; M is the total mass of the system; V′ is the linear acceleration of the center of the mass of the system; dL/dt is the time derivative of angular momentum in the space frame( which is equal to external torque N); I is the 3×3 inertia matrix and ω′ is the angular acceleration; ω×L is the cross product of angular velocity vector and angular momentum vector. In order to solve for the acceleration, velocity and displacement of the system, the mass properties are needed, i.e. mass and inertia matrices of the part or the system.

The invention gets around calculating mass properties of polyhedral objects by getting the information directly from the CAD system when the model is designed. The mass and inertia matrices are defined (unless the object is broken or deformed) once the model is designed. After investigating the available information which can be queried from CAD systems (e.g. ProEngineer™), the developer's toolkit (e.g. ProDevelop™) can be used to extract the information. When the model geometry and constraint information are written out, the mass properties are written into a property file for each part (or subassembly if subassemblies are used) of the model. The file format and content are illustrated in FIG. 30. Note that in the exemplary property file, the invention also includes information other than just mass properties such as units, surface finish, tolerance values, surface area, density, and volume.

When the invention loads the model into the virtual environment, it also loads the property of the parts or subassemblies at the same time. The information can be queried from the part whenever it is needed during the simulation.

Assembly models differ tremendously in terms of size and numbers of parts, from tiny motors to large aircraft. In the assembly operations for the different models, human functionality is different. For some small assemblies, assemblers may use their bare hands with assistance from tools. For large assemblies, they depend on tools, e.g. hoists, to lift some big parts and put the parts in their final locations.

In the VAE system, this fact is taken into consideration. It is easy to use one hand to grab and lift a several hundred pound truck engine in the virtual environment. But this will result in loss of feeling of realism, or even trust in the system. So the inention distinguishes and categorizes the assembly models according to human being's behaviors and abilities.

The criterion that the invention uses is the strength survey data of human beings. For workers on the assembly lines, if he/she can lift the part with one hand or both hands without difficulty, he/she will lift the part and carry the parts to the assembly. This comes from the observation of real world operations and from the concerns of productivity of industry. The invention can categorize a part into three categories by it's weight: (1) being able to be lifted by one hand; (2) being able to be lifted by two hands; or (3) need to be lifted by a tool. If the part can be lifted by one hand, when the user tries to grab the part, he/she can grab it and move it normally. If the part needs to be lifted by two hands and the user tries to grab and lift it with only one hand, the invention can inform the user that the part is too heavy for one hand lifting and suggest he/she lift it with two hands or get help from some tools. For parts that are too heavy to be lifted by assembler's bare hands, the invention can notify the user to use a tool. Although this kind of categorization is crude and simple, it can represent the real world situation. One interesting observation is that novice users tend to reach out his/her hands to pick up relatively small parts even before any explanation is provided on how to grab the parts in the environment. If he/she is put into the environment with a large part in front of him/her, the user usually stays static and waits for instructions.

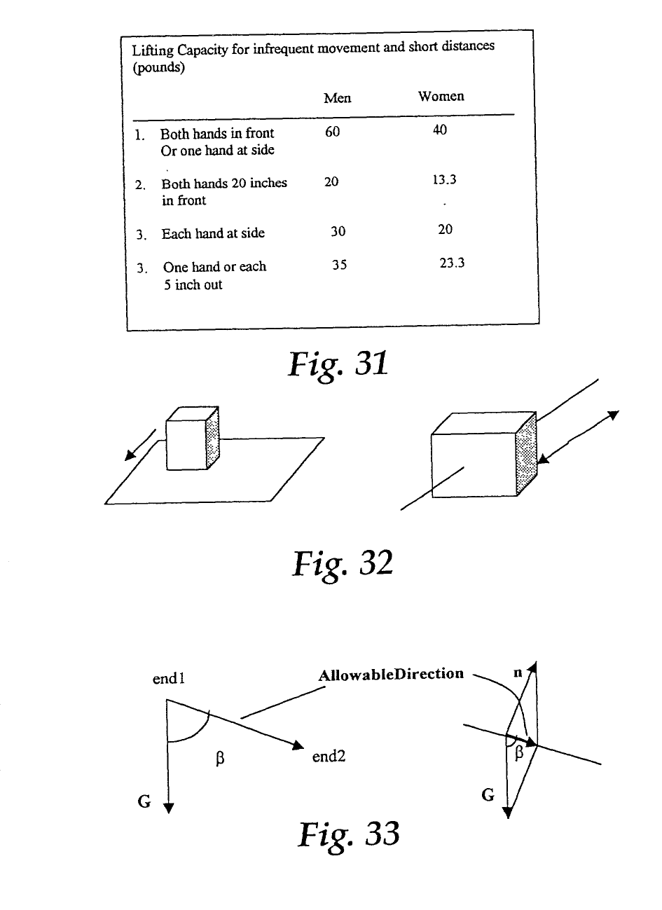

FIG. 31 shows a listing of the lifting capacity for infrequent movement and short distances data used for one embodiment. Although the data for both men and women is provided, this embodiment uses the figures for women to make sure the system works for everyone. If the part is below 20 pounds, the invention indicates that the part can be lifted by one hand; if the part is between 20 and 40 pounds, it indicates that the part can be lifted by two hands; beyond that, the part is put in the category of “needs to be lifted by tools”.

As described above, constrained motion simulation is used to simulate physical constraints in the virtual environment. Although the invention can simulate physical constraints by constrained motion without using collision detection, collision detection is still a critical aspect to verify and validate assembly sequences and orders. Further, since the invention can simulate dynamic behaviors of the parts in the virtual environment, the invention can be used to determine if these behaviors improve the reality feeling in the virtual environment and help the assembly planning process.

The simple categorization of the parts in the assembly models enables the invention to define the scope of dynamic simulation of the parts in the virtual environment. In one embodiment, the invention implements dynamic simulation in cases where the models are small and the parts are not heavy, i.e., in the range of “being handled by one hand”. For larger models and parts, it is not applied since these kinds of behaviors and motions are not allowed in real industrial world anyway because of safety concerns.

During the assembly process planning of operation, certain behaviors such as object bouncing are not of major concern because the invention can assume the user will behave rationally in the assembly operation. He/she may hit a part with a hammer to adjust its shape, but will not unnecessarily hit a part with the base part or other parts. The invention can model the behavior of the part in the user's hand and on the base part. In the virtual environment, first time users may try to throw a part away to see what a virtual reality system is, but an experienced user who wants to verify his/her design would rarely behave in this way. Thus, the Invention provides models for dynamic behaviors on the part while the part is held in the user's hand and while the part is constrained on the base part.

There are three kinds of physical motions for an object discussed in detail below: (1) free motion in space; (2) translation on a plane and along an axis; and (3) rotation about an axis.

Free motion in space of an object is the simplest physical motion to model. An object just follows a ballistic trajectory as described in elementary physics texts. The equations of motion are shown in equations 3.2.1 and 3.2.2. In the equations, t is the time of motion, V₀ and ω₀ are the initial linear and angular velocity vectors, S0 and S are initial and instantaneous position vectors, and finally, Ang₀ and Ang are initial and instantaneous angle values of the object's local coordinate system relative to the global coordinate system.

S=S0+V₀*t+0.5*G*t² (3.1)

Ang=Ang₀+ω₀*t (3.2)

Since the Invention only needs to obtain position and orientation values to update the display and the values can be computed directly with equations 3.1 and 3.2, the Invention does not need to do any integration. The critical issue here is how to obtain the initial linear and angular velocity vectors.

Before the object can move freely in the global space, the part is either held in the user's hand or constrained on the base part. For simplicity, the Invention keeps track of the object's global positions and orientations with respect to time no matter where the object is. The global information of position and orientation of the object is represented by a transformation matrix. Referring to the system graphical scene graph in FIG. 9 discussed in detail above, equation 3.3. can be used to compute the transformation matrix if the part is held in the user's hand. In the equation, [partLocationXform] is the transformation from part DCS to global DCS, [part_matrix] is the transformation matrix from part DCS to palm DCS, [palm_matrix] is the transformation from palm DCS to hand DCS, and [hand_matrix] is the transformation from the hand DCS to the global DCS.

[partLocationXform]=[part_{—}matrix]×[palm_{—}matrix]×[hand_{—}matrix] (3.3)

If the part is constrained on the base part before it can do global free motion, then the scene graph in FIG. 9 is modified to the one shown in FIG. 25. The Invention uses equation 3.4 to calculate the global transformation matrix in this situation. In the equation, the [part_matrix] is the transformation matrix from part DCS to base DCS (this matrix is different from that in equation 3.3). The [baseLocationXform] is the transformation matrix from base DCS to global DCS.

[partLocationXform]=[part_{—}matrix]×[baseLocationXform] (3.4)

At the moment when the object is able to move freely in space, two neighboring instances are chosen (an object in a certain frame is called an instance) and calculate the initial velocity vectors based on the differences of positions and orientations of those two instances (P₁, A₁ are the position and orientation vectors of the first instance and P₂, A₂ are the position and orientation vectors of the second instance), as illustrated in equations 3.5 and 3.6. This is just an approximation method since the Invention can use finite translation and rotation displacement to calculate velocities. However, since the time difference between two neighboring frames is usually very small, the approximation can still provide a good initial condition for the free motion of the object. The positions and orientation values are computed by solving an inverse transformation problem, i.e., compute the translation values and rotation angles from a transformation matrix.

V₀=(P₂−P₁)/(t₂−t₁) (3.5)

ω₀=(A₂−A₁)/(t₂−t₁) (3.6)

When the part is constrained on the base part, if the part is constrained to move on a plane, the part can only slide on the plane. If the part is constrained by two parallel axes, or one axis and a plane parallel to the axis, the part is only allowed to slide along the axis. If the part is constrained on two planes, the part can only move along the intersection line of the two planes. The base part is manipulated in the left hand of the user and the movement direction of the part may be changing with respect to the global frame. Also, FIG. 32 illustrates an exemplary object sliding on a plane or sliding along an axis.

For these situations, the Invention sets up a vector called “AllowableDirection” to represent the allowable translation direction as shown in FIG. 33. In this figure, end1 and end2 are the two end points of an axis, n is the normal vector of a plane and G is the gravity acceleration vector

This vector is computed for different situations as illustrated in equation-3.7.1 and equation 3.7.2. For axis movement, “AllowableDirection” is along the axis. For a plane movement, “AllowableDirection” is a vector that is perpendicular to the plane's normal vector.

AllowableDirection=end2−end1 (3.7.1)

AllowableDirection=n×(G×n) (3.7.2)

The symbol “×” represents cross product of two vectors. If the angle between G and AllowableDirection is greater than 90°, the Invention negates AllowableDirection and normalizes AllowableDirection for later computation.

When the Invention computes AllowableDirection, end1, end2 and n in FIG. 33 should already be transformed to the global coordinate system in order to compare with G. The original data are obtained in the part's local coordinate system. The Invention transforms them from the local DCS to global DCS using equations 3.8.1 and 3.8.2. [partLocationXform] is the transformation matrix calculated from equation-5. [partLocationXform_forVector] is the same transformation matrix except the translation values are set to be zeros because end1 and end2 in part DCS are points while n in part DCS is a vector.

end1,2=(end1,2in part DCS)*[partLocationXform] (3.8.1)

n=(n in part DCS)*[partLocationXform_{—}forVector] (3.8.2)

The part may not be able to move if the Invention takes static friction into account, even if there is a direction to move. Suppose the static friction coefficient between the part and the base part is fs, the condition for the part to be able to start moving is checked with equation 3.9. After the motion begins, dynamic friction coefficient fd (which is smaller) is used to get the acceleration a by equation-10a. In the equation, β is the angle between G and AllowableDirection, m is the mass of the object, |G| is the magnitude of G.

Angle(between G and AllowableDirection)<90−tan⁻¹(fs) (3.9)

In this situation, the equations of motion are described in equations 3.10.1-4. In these equations, a, V and P represent the acceleration, velocity and position of the object. Notice that AllowableDirection is changing with the movement of the base part, the position of the part is actually obtained by simple numerical integration using Euler's method.

a=F/m=(m|G|cos(β)−fd*m|G|sin(β))/m*AllowableDirection=(|G|(cos(β)−fd*sin(β))*AllowableDirection (3.10.1)

Vₙ₊₁=Vₙ+a*t (3.10.2)

Pₙ₊₁=Pₙ+Vn*t+0.5*a*t² (3.10.3)

dP=Pₙ₊₁−Pₙ (3.10.4)

The vector dP will be used to form a transformation matrix [translate_by_dP] to update the position of the part. But before doing this, the Invention transforms this vector to the base DCS from the global DCS by equation 3.11 since all the computation is done in global DCS. The new part_matrix (the transformation matrix of part DCS in base DCS) is calculated and updated by equation 3.12.

(dP in base DCS)=dP*[baseLocationXform_{—}forVector]⁻¹ (3.11)

[new_{—}part_{—}matrix]=[part_{—}matrix]×[translate_{—}by_{—}dP] (3.12)

For the second kind of physical motion, the part is constrained on the base part by an axis, the part will tend to rotate about the axis if the center of mass of the part is not on the axis. In this case, first, the invention transforms end1, end2 and CM (the center of mass) from the part DCS to the global DCS using equation 3.13. The vector RotVec (the vector and object is rotating about) and CMVec (the vector that passes CM and perpendicular to RotVec) and can be obtained from equation 3.14 and equation 3.15.

(end1,2; CM)_{global}=(end1,2; CM in part DCS)*[partLocationXform] (3.13)

CMVec=(end2−end1)×((CM−end2)×(end2−end1)) (3.14)

RotVec=G×CMVec (3.15)

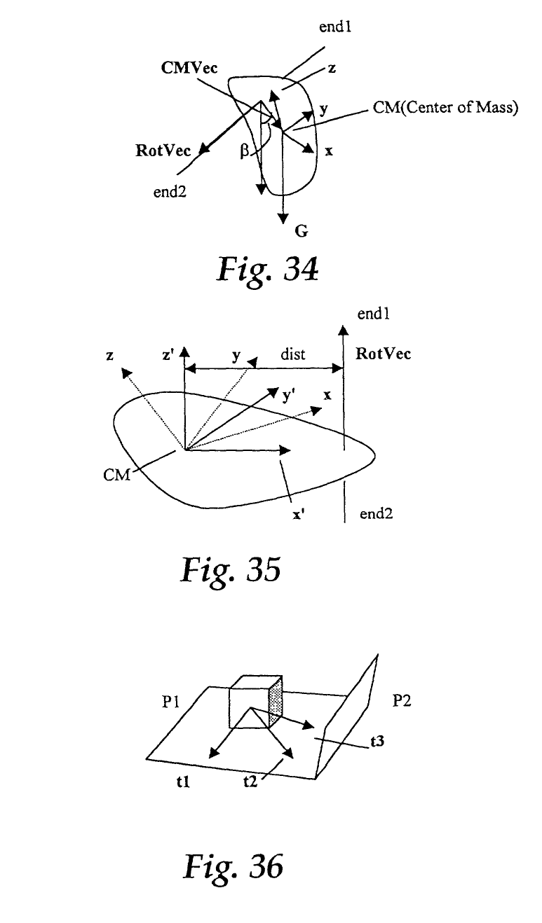

FIG. 34 illustrates rotation about an axis with a local coordinate system at the origin of the center of mass having an orientation that is defined when the part is designed in a CAD system.

In this particular situation, Euler's equation can be simplified to equation 3.16, where Jaxis is the moment of inertia of the object with respect to the axis of rotation, ω and α are the angular velocity and acceleration, m is the mass, |G| and |CMVec| are the magnitudes of vectors G and CMVec, β is the angle between vector CMVec and RotVec shown in FIG. 34, and fr is the rotational friction coefficient. For simplification, the frictional torque is represented as fr*ω.

Jaxis*α=Torque=m*|G|*|CMVeC|*sin(β)−fr*ω (3.16) Or

α=Torque/Jaxis=(m*|G|*|CMVec|*sin(β)−fr*ω)/Jaxis (3.17)

In equation 3.17, G is constant vector, CMVec and β can be easily calculated, m can be queried from the part directly, so the only thing left is to compute Jaxis. The extraction of mass properties of the part, including the inertia matrix Icm with respect to center of mass is discussed above. Icm is a second order tensor To calculate Jaxis from Icm, the first step is to create another coordinate system, with the origin still at the center of mass, and one axis (z′) parallel to RotVec as shown in FIG. 34. The next step is to find a transformation matrix that relates the two coordinate systems. This matrix, T, can be formed by rotating z to z′. The new inertia matrix of the object, Icm′, with respect to the new coordinate system x′-y′-z′ can be obtained by equation 3.19.

Icm′=T*Icm*T^{t} (3.19)

Let z′ be the axis of rotation, the moment of inertia about z′ is just Iz′z′, or Icm. Using general parallel axis theorem, with dist calculated from equation 3.20, Jaxis can be computed from equation 3.21. FIG. 34 illustrates x-y-z as the original coordinate system with Icm and x′-y′-z′ as the new coordinate system with z′ parallel to RotVec.

dist=((end1−end2)×((end1−end2)×(CM−end1)))•(CM−−end1) (3.20)

Jaxis=Iz′z′+m*dist² (3.21)

With Jaxis computed, the Invention employs equations 3.22.1, 3.22.2 and 3.22.3 to integrate the rotation angles of the object about RotVec. In equation 3.22.1, α is the angular acceleration computed in equation 2.17, ωₙ and Aₙ are initial angular velocity and angles for each integration step.

ωn+1=ωₙ+α*t (3.22.1)

An+1=Aₙ+ωn*t+0.5*α*t² (3.22.2)

dA=A−A₀ (3.22.3)

Finally, dA is used to form a rotation matrix to adjust the old part transformation matrix in base part DCS. The rotation axis, RotVec does not necessarily pass through the origin of the part DCS, The transformation matrix [rotation_dA_about_RotVec] is a matrix combining a translation of end1 back to origin, a rotation matrix, and a translation of end1 from origin to its initial position. The new matrix is calculated in equations 3.23.1 and 3.23.2.

[rotation_{—}dA_{—}about_{—}RotVec]=[trans_{—}end1_{—}origin]×[rotation_{—}dA]×[trans_{—}end1_{—}origin_{—}back] (3.23.1)

[new_{—}part_{—}matrix]=[part_{—}matrix]×[rotation_{—}dA_{—}about_{—}RotVec] (3.23.2)

When a part moves in space, or moves on a base part, the part should stop moving if its motion is blocked, e.g., stopped by the table, or stopped by the base part geometry. As mentioned before, since a purpose of simulating dynamic behaviors is to assist assembly operation, the Invention does not pay much attention once the part is out of the user's “virtual hand” or is away from the base part. For the former case, the part stops moving if the part hits the table or other environment objects and the Invention does not go further to figure out the balanced resting position or orientation for the part on the table. This short cut saves computation time and lets the Invention concentrate on interaction issues.

The situation is complicated if the part moves on the base part, which is illustrated in FIG. 36. In this figure, the part can move in any direction on the base part and P1 and P2 are planes (or geometry) on the base part. The part is sliding on a plane P1 on the base part. If the part moves in the direction of t1, collision detection is used to check whether the part is still touching the base part. If the part slides away from the base part, it goes to free space. If the part moves along t3, collision detection is used to check if the part will be blocked by P2. If the part moves along t2, it is unclear which situation will occur first so both situations are checked. This brings up a conflicting collision problem—a simple report whether the part is colliding with the base part is not enough. If the part is moving along t1, collision detection of the two touching surfaces is performed; if the part is moving along t3, the collisions of the part other than with P1 should be determined. The same situation will occur when a shaft is inserted into a hole, the part may be sliding out of the base part or blocked by other geometry other than the hole.

In one embodiment, a RAPID™ collision detection facility developed in at the University of North Carolina at Chapel Hill is used. The facility requires triangular data of the model as well as the position and orientation of the model in the global space. The facility can report the collision status (colliding or not) and the intersecting triangle pairs between two models accurately. It supports the option of reporting the first collision or report all of the collision pairs. A direct way to solve this problem is to let RAPID find all the colliding triangles, and distinguish the interfering ones on P1 with those on P2. However, this is not a feasible solution for several reasons.

First there may be many holes on P1 and this will result in a great number of triangles on P1. Looping through all the triangles will be time consuming. Second, due to floating number errors, RAPID may not find all the touching triangles (this is not a problem of RAPID itself, this is usually caused by the series of transformation matrix multiplication). And thirdly, asking RAPID to report all the collision pairs is much slower than reporting the first collision (about a factor of 10).

The solution is to modify RAPID to solve this specific problem. Since the Invention mainly focuses on planar and axial constraints, RAPID was modified to solve the coplanar or coaxial interference checking problems. Besides its own options to perform different levels of computation, “FIRST_CONTACT” and “ALL_CONTACT”, another set of options for coplanar and coaxial situations were added: “KEEP_COPLANAR” (report if the triangles are parallel and the distance between them is less than a tolerance value), “SKIP_COPLANAR” (do not report if the triangles are coplanar and very close), “SKIP_CYLINDER” (do not report if it is a equal-diameter coaxial insertion), “NOCARE_COPLANAR” (normal mode, do not consider coplanar or coaxial problems). When the part moves on the base part, the modified RAPID facility perform two collision detection checks: one for checking if the part is still touching the base part and another one for checking if the part is blocked by geometry of the base part other than the plane or the cylinder the part is sliding on. Since the first check will always detect the collision if the part is touching the base part, the “KEEP_COPLANAR” option is selected. Also, since the second check will always ignore the collision between the touching triangles, “SKIP_COPLANAR” or “SKIP_COAXIAL” options are employed.

In FIG. 36, if the part moves along t1, the first check will tell whether the part still touches the base part; if the part moves along t3, the second check will notify whether the part is blocked by P2; if the part moves along t2, whichever of the two check is first will put the part either in space or on the base part.

With the collision detection problem resolved, the interaction issues in the virtual assembly environment can be analyzed. In the virtual environment, there is the user's virtual hand(s), the virtual part, the virtual base part, virtual tools, and virtual environment objects. Since how the virtual part is being handled and assembled is part of the Invention, the part is the center of the whole system. The user can grab or lift the part with his/her bare virtual hands or with some virtual tools, so the user is the decisive factor for the virtual part and the virtual tools. If the user uses a virtual tool to manipulate the virtual part, the virtual part should observe feasible motion defined by the virtual tool.

Different state variables are used to define the status of a virtual part in the virtual environment. The states are: INHAND (grabbed or lifted by the user), ONTOOL (manipulated by a virtual tool), ONBASESLIDE (constrained on base and can move relative to the base part), ONBASESTATIC (constrained on base and cannot move relative to the base part), INSPACE (free moving in space), STATIC (remaining in the same position and orientation), and PLACED (placed on the base part in the final assembled location). The virtual part will be handled according to different states. If the virtual part is INHAND, the motion of the part is totally decided by the user's virtual hand. If the part is ONTOOL, its motion is decided by the virtual tool, whose motion is decided by the user. If the part is ONBASE or INSPACE, dynamic simulation methods discussed above will be used to determine the motion of the virtual part. If the virtual part is STATIC, no action is performed.

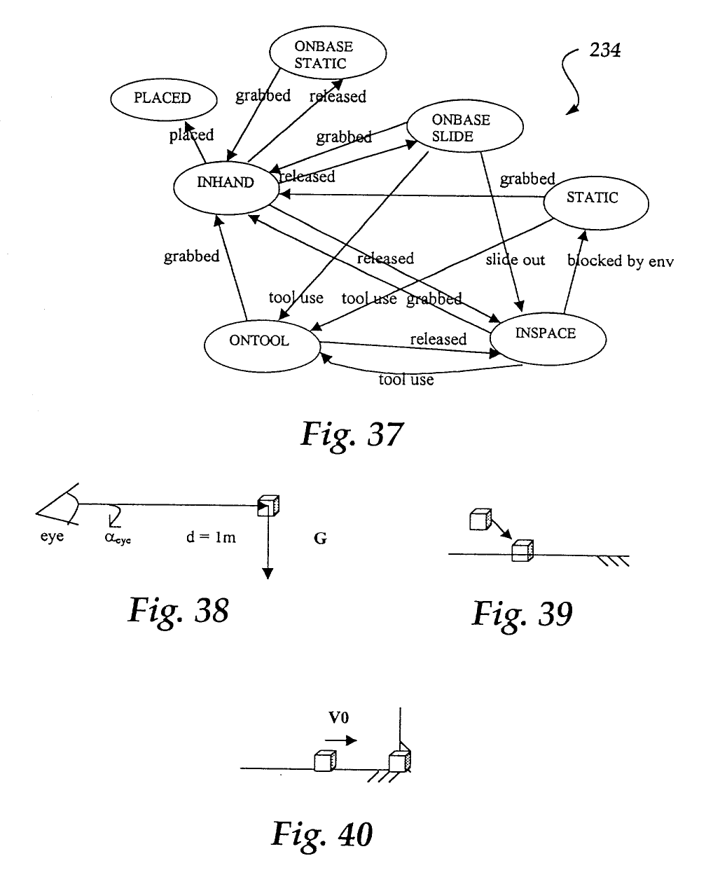

The states of the virtual part can change from one to another. A transition state diagram 234 is shown in FIG. 37, which is used to demonstrate the changes of the state of a virtual part and the possible causes of these changes. The state diagram 234 also shows the interactions between the user's virtual hand(s), the virtual part, the virtual base part, the virtual tools, and the virtual environment objects. Also, this state diagram 234 provides a convenient way to handle the part in different situations. Whenever an interaction occurs, the state of the part is updated, the part is then handled according to its previous state and the current state.

If a part moves freely in space, it will follow a simple ballistic trajectory as in equation 3.3. Once the initial conditions are known, the only thing that changes the motion of the part is its gravity with acceleration G, which is 9.8 (meter/second²) or 385.8 (inch/second²). Surprisingly, to let the user feel that the motion of the part is realistic, G is scaled down to a smaller value using a scale factor 0.2-0.3. The scale factor can be determined by trial and error.

Another interesting and conflicting observation is that when the integration for a virtual part rotates on the virtual base part, there is not a need to scale G down when calculating angular acceleration using equation 3.17 in order to enable the user to feel that the rotation is realistic.

The explanation of this phenomenon can be found in the nature of the immersive virtual environment. In real world space, humans usually use their eyes to follow the moving objects and human's eyes can follow a moving object even when the object moves with an acceleration greater than gravity. Although in the real world human eye movement can be as fast as 600 degrees/second, in a virtual environment the human being's viewing update is usually determined by the movement of a tracking device attached to his/her head, instead of his/her eyes. Even if the graphics of the system can be updated 30 frames per second, the movement of the human's head, especially rotation, is limited to peak velocities of about 600 degrees/second for yaw, and 300 degrees/second for roll and pitch. In a fully immersed virtual environment, the user usually wears a head-mounted-display device, i.e., a helmet. The weight and inertia of the helmet further limit the motion of the user's head.

Suppose the object is 1 meter away from the user's eyes. If the object is dropping with normal gravitational acceleration as can be seen in FIG. 38, the head of the user needs to rotate with an angular acceleration computed in equation 3.24. This requires the human's head needs to rotate 280 degrees in one second (0.5* α_{eye} * t²). This is close to the peak ability of head movement (300 degree/second) without a helmet. It is impossible for the user to rotate his/her head in the virtual space with a helmet on his/her head to fulfil this requirement. In FIG. 38, a schematic overview is shown of a human eye following the motion of a dropping object.

α_{eye}=|G|/d=9.8/1=9.8(rad/second²)≈561(degrees/second²) (3.24)

If the scale factor is used (about 0.250, the motion requirement becomes 280*0.25=70 (degrees) in one second, which is a quite reasonable number. Therefore, the appropriate gravity acceleration in virtual space is determined by the human factor, i.e., the ability of human's movement in the virtual environment. This also can explain why the gravity acceleration needs not to be scaled down for rotating objects: the rotation of the object is usually a local motion, the position of the object in space does not change much and the user does not need to move his/her head to follow the motion of the object.

When a virtual part drops down from the user's hand or from the base part, it may be stopped by a virtual table and stay on the table, or it may also fall down onto the ground in the virtual environment. It is very inconvenient and sometimes even bothersome to go to grab the part again from the floor. In this case, the Invention can let the virtual part go back to its original position and orientation when the virtual part reaches the floor in the virtual environment.

When a virtual part is stopped by a virtual table or other virtual environment objects, the part's state changes from INSPACE to STATIC. At that time, the virtual part may be penetrating into the virtual table, as shown in FIG. 39. This is the most basic problem in traditional physically based modeling systems. Usually, the object is moved back to its position and orientation of last frame and moved with a smaller step until the exact contact point is found. To get around this problem, the object is moved back to its position and orientation of last frame, i.e., when it is not colliding with the table.

However, the above trick can not be used when the part is stopped by the base part geometry since the user can view the part from different angles, as shown in FIG. 40. In this case, the object is moved back to the position and orientation of the last frame and the linear and angular velocity vectors are set to zero. So the integration will start from zero velocities and finally it will remain in a location that is very close to the blocking geometry of the base part. The result of this method is that the part slows down when it hits the base part.

Since there can be multiple virtual parts in the virtual environment, every part may be in its own different state at the same time. To handle all of the parts correctly and conveniently according to its current state, a traversal function goes through the parts and takes corresponding actions according to their respective states.

In equation 3.10 and equation 3.22, the most approximate integration method is used. Although its accuracy is of O(h2), practically it is good enough. The reason is that the absolute positions and angles are not critical and the approximation is enough as long as the motion looks correct. For example, it is difficult to tell the difference of several degrees in the virtual space when a part is rotating. If the part follows a pendulum like motion, there is a tendency to believe the motion is correct.

An important aspect of physically based modeling in virtual assembly is to assist in simulating the design intent of the designer of a part. Overall, constrained motion simulation is the convenient way to achieve this goal. The constrained motion methodology aligns the concepts of constraints in the assembly design with the actual assembly operation. When physical constraints are simulated, not only the designer's intent is represented, but also the processes in which the assembly is physically carried out are shown. This aspect of the invention also provides a direct and intuitive way of assembly evaluation since the VAE system is simulating the physical assembly process. This simulation can be used for all sizes of assembly models and is computationally effective since it avoids extensive collision checking and motion calculations in every frame.

### SWEPT VOLUME GENERATION AND TRAJECTORY

The invention provides for generating swept volumes directly in a CAD system (e.g., ProEngineer™). Also, real-time assembly trajectory and sweep volume editing is provided in the virtual environment by the invention. The swept volume instances capture the position and orientation of the moving object in each frame, which can be picked, removed and modified until the trajectory is satisfactory to the user. The trajectory is sent to a CAD system by the invention where it is used to generate the swept volume. The swept volumes can then be taken back from the CAD system into the virtual environment for further evaluation. Swept volumes generated in this way, are accurate concise, and easy to process in the CAD system.

The transformation matrices information obtained from the coordinate system of the base part or the global space becomes meaningless outside the virtual environment. The real issue is the relative information between the swept volume instances themselves. As a convenient reference for the swept volume instances, the first instance is picked as the reference for all of the other instances. Suppose there are T1, T2, T3, etc., as the transformation matrices. The relative transformation matrices of the instances to the first instance can be obtained as T2T1⁻¹, T3T1⁻¹, T4T1⁻¹, etc.

The final problem is to find the translation values and rotation angles, given a pure rotation and translation matrix. This is a typical transformation inverse problem. The translation elements are relatively easy to calculate. The rotation angles are not unique because they depend on the order of rotations performed about the X, Y and Z axes and some special cases. If the angles are computed using a combination matrix composed by rotations in a certain order, e.g., first rotate by Y, then Rotate by X, and finally rotate by Z, this order is kept until later when the matrices are created.

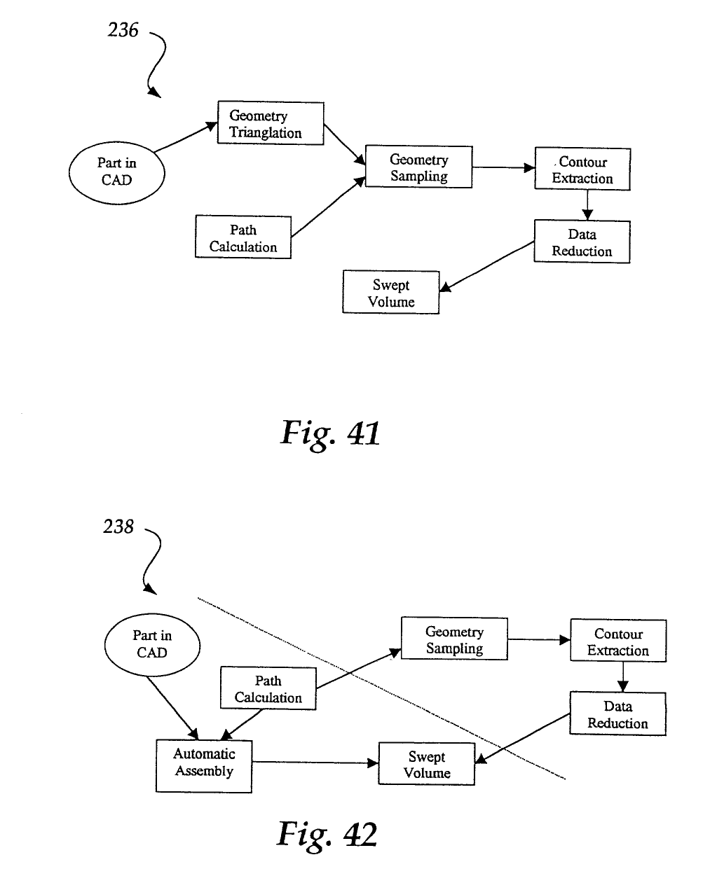

To generate swept surfaces and volumes using an implicit modeling approach, the geometric model and a path describing the part motion (called ST) need to be defined. The model geometry is represented by a file in stereo-lithography format. The file can be easily created in CAD systems where the part or object is designed. The path is defined by a series of transformation matrices (T1, T2, . . . ). The transformation matrices are defined in the global coordinate system. The geometry of the part is used to generate an implicit model in the form of a volume, called, V1; Another volume which can strictly bound V1 as it moves along the path ST, called Vw is also constructed. As V1 is swept through Vw by moving in small steps, Δx, the Boolean operation is used to sample V1 in Vw. Finally all of the samples of V1 in Vw are extracted using a contouring algorithm to form the boundary swept volume. The output of the algorithm is also triangles that approximate the swept volume surface. The data size is usually very big. A triangle decimation method is then used to reduce the number of triangles. A flow chart 236 of the implicit modeling algorithms is shown in FIG. 41.

Although the algorithm is robust to handle almost every kind of geometry, the problem is that the data size of it's output is too big and the accuracy is relatively low. Its application is limited in cases where the accuracy requirement is low. The error is first introduced when the part geometry is triangulated. Then more errors occur in the working cell sampling. Finally triangle decimation eliminates many key points that represent the swept surface geometry.

Another limitation lies in the algorithm itself Since the output is a triangle file, it is very difficult to take it back to CAD systems. Despite past efforts to load triangle data into CAD systems, it is usually not an easy task because of the complex geometry of the swept volumes.

Because of certain limitations of tracking technologies and computing power, sophisticated design modification has proven difficult to perform in visualization systems. However, information obtained from the visualization systems needs to be sent back to the CAD system. This also applies to generated swept volumes. To realize this goal, an overview 238 of a method for generating swept volumes directly in the CAD system is shown in FIG. 42. In this figure, on the right side of the dashed line is the implicit modeling method shown in FIG. 41.

After the virtual part trajectory path is obtained, the trajectory is sent to the CAD system. This is a relatively simple task since the trajectory just consists of transformation matrices representing the position and orientation of the instances. The same virtual parts are repeatedly put together according to the obtained trajectory, then the geometry is merged together into a single part using a Boolean operation. The resulting geometry is the swept volume. In one embodiment, the automatic assembly and merging are done by developing a facility using the ProDevelop™ program, which is the user's development API supplied by Parametric Technology Corp., the vendor of ProEngineer™. This method can be used with any other CAD systems if a similar API is provided.

Given the positions and orientations of the instances, all of the instances are assembled together. In the CAD system, if using the merge/cutout function (a function to perform a Boolean operation for two parts) to merge two parts together in assembly mode, one basic rule is that these two parts cannot be the same, which is an obvious restriction.

First, a copy of the part to work on as a base part is made and it is renamed as another part, e.g., “partbase”. Another restriction is that these two parts are explicitly assembled together, i.e. the second part needs to be assembled with references to features on the first part. In one embodiment, the ProDevelop™ program is employed to provide functions that can assemble a part to an assembly by a transformation matrix directly. The assembly performed this way is called “package assembly”. This is a non-parametric move so the merge function can not be used if the part is assembled this way (This is a general requirement for assembly modeling). The reason is also clear: when the surface intersections of the two parts are computed and all of the surfaces have to be parameterized in the same coordinate system. Also if the base part is modified, the relative position of the part relative to the base part may be changed.

Therefore, when assembling the part on to the base part (actually a copy of the same part), some kind of reference on the base part is created for assembling the part in reference to the created features. For example, some datum planes on the base part can be created and used with align/mate constraints to explicitly assemble the part. However, since the position and orientation of the part relative to the base part is known, the most natural way to do it is by creating coordinate systems on the base part as a datum feature and use the coordinate system constraint method to assemble the part.

In a feature-based CAD modeling system, the “chunks” of solid material from which the models are constructed are called “features”. Features generally fall into one of the following categories: base feature, sketched feature, referenced feature or datum feature. The coordinate system feature for the invention can employ a referenced datum feature. But the situation is that it is not always practical to create the coordinate systems interactively since there are perhaps more than one hundred instances to deal with.

The invention provides for creating coordinate systems automatically. Since a coordinate system is a complete feature, a UDF method in the CAD system can be used to create it. The term UDF (User Defined Feature) refers to a file that contains feature information. A UDF acts like a feature made up of elements. A UDF can be defined interactively in an active session of the CAD system. Each UDF consists of the selected features, all their associated dimensions, any relations between the selected features and a list of references for placing the UDF on a part. Once the UDF is defined, it can be put into a UDF library and used to create the same types of features. To illustrate the concepts and procedures of UDF, detailed procedures of creation of the coordinate systems as UDFs are described as following.

Every part has it's own default coordinate system. Interactively, a coordinate system is created referring to the default coordinate system. Actually the default coordinate system itself can be a UDF which refers to nothing. The default coordinate system is picked, named “DEFAULTCS” and saved in the UDF library. When creating a coordinate system referring to a default coordinate system, the offset values are specified along X, Y, Z directions and rotation angles about X, Y, Z directions of the new coordinate system relative to the default coordinate system. The rotation angles are order sensitive. Also, the values provided are not important because the values will be modified when the UDF is used. Once the new coordinate system is created, the new created coordinate system is picked and defined as a UDF. The CAD system will then go through certain procedures to define the detailed issues of the UDF. The two most important questions are:

1. Which feature does the UDF refer to?

Here, the reference is DEFAULTCS.

2: What are the values that need to define the relationship of this UDF with the reference?

Obviously, the X, Y, Z offsets and X, Y, Z rotation angles.

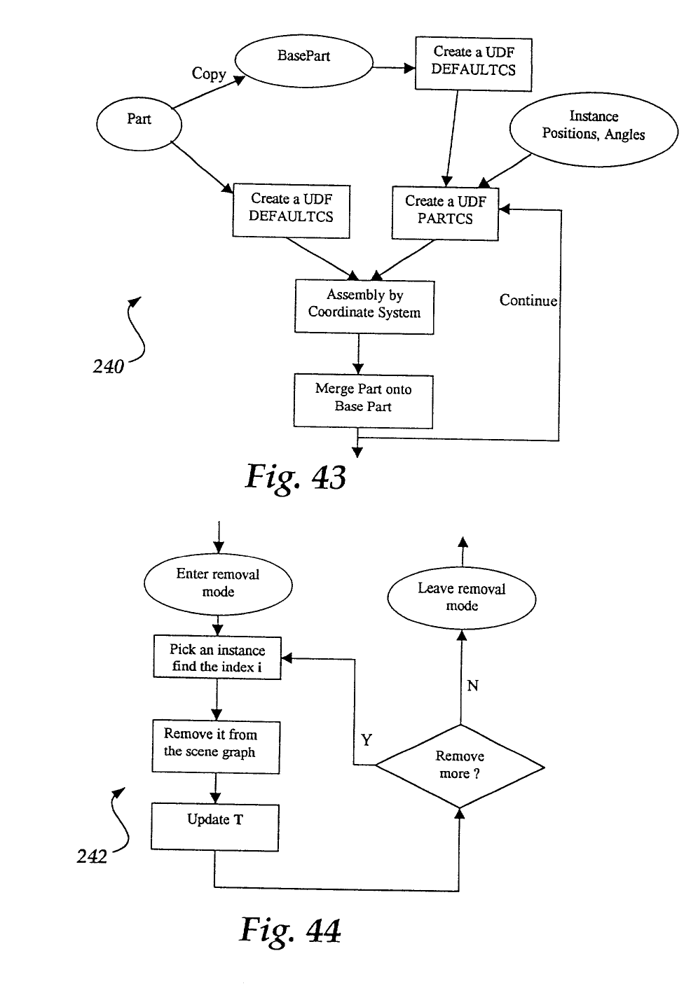

Once this UDF is defined, it is saved as PARTCS in the UDF library. A flowchart 240 is shown in FIG. 43 for a UDF method that employs automatic assembly and swept volume generation. On the base part, a default coordinate system is first created by using DEFAULTCS, then the coordinate systems from PARTCS UDF is created by referencing this DEFAULTCS. The actual positions and orientations are decided by the values we obtained from the trajectory calculation. Also, a DEFAULTCS is created on the part that is going to be assembled. The part can then be placed by referencing the PARTCS on the base part and DEFAULTCS on the part. Once they are assembled, the merge function is used to merge the part into the base part. All the instances can be processed this way and finally the base part represents the parametric model of the swept volume. The complicated processes of surface intersecting, merging and re-parameterization are taken care of inside the CAD system.

No matter what kind of method is used to compute the swept volumes, analytical or numerical or the method discussed above, the first task is to obtain the trajectory of the part as it moves in the space.

When the user moves the part with his/her hands in the 3D virtual space of the VAE system, the invention determines the trajectory of the part during the motion. The volume of the part occupied in a certain time is called an instance. Actually, it is the combination of the part geometry, part position, and part orientation. The whole swept volume is the union of the all the instances. The user is given a choice whether he/she wants to create the swept volume while the part is moving held in his/her right hand. All the actions below will be effective if the user chooses to create the swept volume. Once the system is in the volume creation mode, the defined volume begins whenever the user grabs the part and stops whenever the user releases the part.

Referring to the scene graph in FIG. 9, in every frame, the invention calculates the transformation matrix of the part in the global DCS using Equations 4.1.1, 4.1.2 and 4.1.3.

[partLocationXform]=[part_{—}matrix]×[palm_{—}matrix]×[hand_{—}matrix] (4.1.1)

(geometry of part in global)=(geometry of part)×[partLocationXform] (4.1.2)

(geometry of base in global)=(geometry of base)×[baseLocationXform] (4.1.3)

where [partLocationXform]-transformation from part DCS to the global DCS

[part_matrix]-transformation from part DCS to palm DCS

[palm_matrix]-transformation from palm DCS to hand DCS

[hand_matrix]-transformation from the hand DCS to global DCS

[baseLocationXform]-transformation from base part DCS to the global DCS

In theory, where the swept volume is created makes no difference since the swept volume will form a whole boundary and can be moved to anywhere. If no environment evaluation is performed, the swept volume is created in the base part DCS. Equation 4.2 is used to calculate the transformation of the part in base part DCS.

[partInBaseLocationXform]=[part_{—}matrix]×[palm_{—}matrix]×[hand_{—}matrix]×[BaseLocationXform]⁻¹ (4.2)

A matrix array T is declared that can hold the transformation matrices for every instance. Also, the instance number is stored before the user stops the swept volume. For every instance, the part geometry is copied and transformed using [partInBaseLocationXform]. So if the base part moves, all the instances will move with it. The reason for the need to copy the geometry of the part is because the instances are picked individually and independently. Otherwise, the instances can be displayed by referring to the same geometry, but they can not be picked separately.

The trajectory represented by T is time independent since the trajectory totally depends on the transformation matrices. This is a very useful property is discussed in greater detail below.

Swept Volume generation is usually not a real time process. Sometimes, it may be time consuming. One question is what happens if the user is not satisfied with a swept volume after it is created? ( e.g. maybe the user wants to take a different trajectory path.) The invention provides for real time swept volume editing functionality before the swept volume is created from all the instances. The editing functionality includes removal and modification.

If the user does not care about the information or the shape of the swept volume between two instances, the in-between instances can be removed. The removal of one or more instances may change the swept volume greatly.

In order to let the user pick the instances by his/her virtual fingers, the finger positions are computed relative to the swept volume and the invention is aware when the swept volume is moving with the base. The calculation of the positions or the fingers in the global space is relatively simple when the virtual hand model is fully dexterous. For simplicity, the position and orientation of the finger tip in the virtual hand DCS is represented by [fingerInHandXform].

Equations 4.3.1 and 4.3.2 are employed to bring the fingers and the swept volume to the global DCS so that they can be compared in the same coordinate system. In one embodiment, the invention employs a built in intersection check mechanism in the graphical environment facility to create some line segments on each finger tip on the user's right hand and call the intersection function to perform the intersection of the line segments with the geometry that was copied for the instances. This symbolizes the finger picking.

[fingertipxform]=[fingerInHandXform]×[hand matrix] (4.3.1)

[fingertipInBaseXform]=[fingertipxform]×[BaseLocationxform]⁻¹ (4.3.2)

Once the instance is picked, its geometry is removed from the scene graph. Also the matrices array T is updated. A flowchart 242 of the removal mode process is shown in FIG. 44. The symbol “NoI” means the total number of instances.

Besides instance removal, the invention also provides for instance modification functionality. This allows the user to change the shape of the swept volume by changing the position and orientation of the instances. It is kind of a “refining process”. In many cases, the user may not want to move the instance in a large step, so the invention lets the instance translate and rotate in its own coordinate system. The invention makes a transformation matrix called [modifyXform]. All the translation and rotation in its own coordinate system are concatenated to this matrix. Suppose the transform matrix before the modification is [locationxform] ( in global DCS or in base DCS ), then Equation 4.4 is used to get the new matrix.

[newLocationXform]=[modifyXform]×[locationXform] (4.4)

The [newLocationXform] is copied into the trajectory array T. In order to assist the modification process, we use the highlighting feature to clearly indicate the picked instances. In addition, three line segments are created to represent a physical coordinate system and will be displayed on the instance when the user picks an instance. The user can easily see where the translation and rotation is going to be performed.

In some cases, translation and rotation may be not convenient if the user wants to move some instances freely. It is easier sometimes to position and orient an instance directly by one's hands. It may not be practical to grab the instance and move it around since all the instances are close to each other and it is difficult to grab a certain instance.

However, the invention can still use a virtual finger tip to pick an instance. After the instance is picked, this instance is attached to the right hand DCS. When the instance is finally placed in a certain position, global transformation matrix for the instance is calculated. The new matrix can be computed by equations 4.5.1 and 4.5.2. In the equations, [instanceInHand] represents the transformation between the instance and the hand at the time when the instance is picked. [instanceMatrix] is the global matrix of the instance before it is picked. [instanceInBase] is the new matrix of the instance in base DCS. Also notice that [hand_matrix] in the two equations are obtained at different time.

[instanceInHand]=[instanceMatrix]×[hand_{—}matrix]⁻¹ (4.5.1)

[instanceInBase]=[instanceInHand]×[hand_{—}matrix]×[baseLocationXform]⁻¹ (4.5.2)

One interesting problem is how to tell the system to stop the movement of the instance. Within the virtual environment, the primary interaction actor is the user's right hand since the left hand is holding a base part and the invention lets the fingers carry out this task. Because all of the fingers are dexterous and one finger can be used to pick the instance, the invention can use the distance between some other fingers to indicate the command. When the instance is picked, two fingers are moved close to each other, i.e., let the distance between the two fingertips be smaller than some predefined value. The distance between two fingers is calculated while the instance is picked and moved around. If the user opens those two fingers, i.e., the distance is greater than a certain value, the movement of the instance is stopped and the new matrix is calculated using equations 4.5.1 and 4.5.2.

This interaction method provides an additional interaction method in the virtual environment. Usually 3D GUI picking is not very efficient when the user needs to send a quick command. And in some cases, both the user's hands may be busy. Using the fingertip position testing can be used to generate some simple yes/no, start/stop commands and the implementation of the interaction is easy.

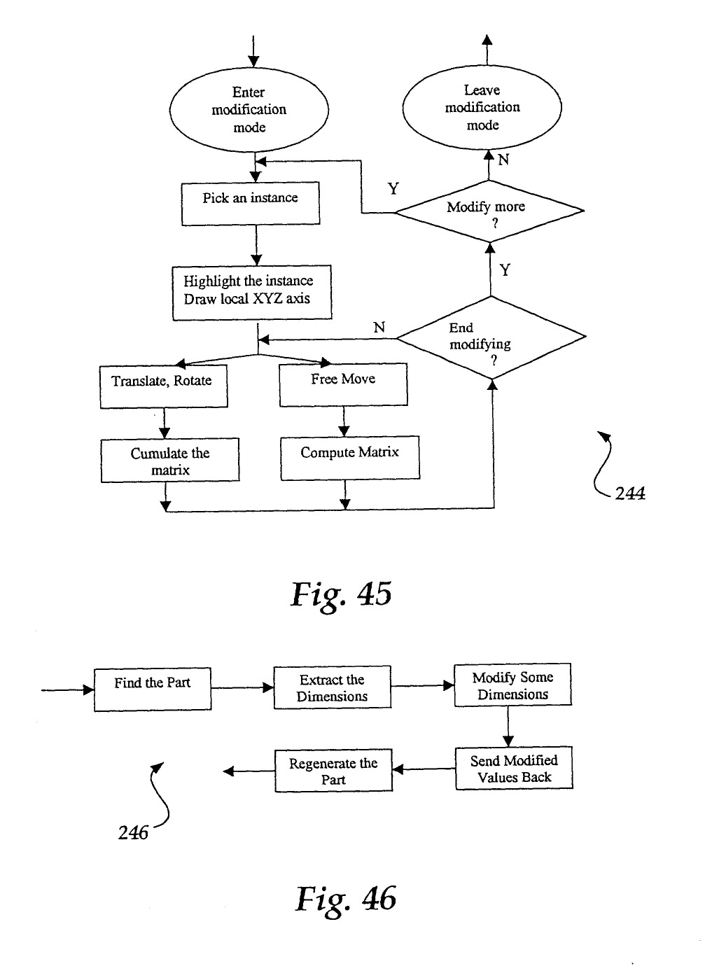

A flowchart 246 of the instance modification process is shown in FIG. 45. Using the instance removal, and modification, a swept volume is created. In this way, the evaluation is almost done before the swept volume is created.

After the swept volume is created, the invention can load it back into the VAE system in the position where it is created. For convenience, the transformation matrix for the first instance to represent the transformation of the swept volume is stored. The created swept volume behaves as a new part in the assembly model. The user can now perform the swept volume related evaluation tasks in the virtual environment.

One interesting combination is the creation of a swept volume while the part is undergoing the constrained motion. Another byproduct of the swept volume editing is the real time part design. Since the invention can modify the shape before the volume is created, it can be used as a design tool. Very sophisticated parts can be created out of very simple geometry.

Additionally, the created swept volume can be a reference to the subsequent assembly operations. As discussed above, the invention enables a complex assembly to be studied. For some critical parts, its path is reserved by the representation of the swept volume, which means that when other parts are assembled, they should not interfere with the swept volume. For example, if the assembly of an engine is being studied, it is well known that the spark plugs are the parts that need to be replaced sometime and it is important to make sure that their trajectory path remains clear. In this case, a user could sweep a spark plug in the assembly, edit it till the required path is known, then create the swept volume and load it back. The spark plug swept volume would be left on the assembly when performing the assembling process for other parts. If no parts cut the spark plug's swept volume at their final position, then the user would know for sure that the maintainability of the engine for this item is guaranteed.

Definitely the collision detection plays an important role in the invention. The interference check is done accurately using the geometry data instead of just visually. The collision detection makes it possible that every operation will be valid. Real time collision detection is been included in the Invention. The combination usage of swept volume and collision detection is also a powerful feature. For example, if a part is swept along certain paths and checked for collision between the part and other parts, and if collision occurs, the user can clearly find the positions or locations of the interference.

### PARAMETRIC DESIGN MODIFICATION

In one embodiment, the invention employs a parametric CAD system (Pro/Engineer™) and a developer's toolkit that provides access to its database: ProDevelop™ (or ProToolkit™). Hereinafter, ProE and ProD, respectively. ProD is a programming interface to ProE that allows developers to directly access to the database of ProE to perform unique and specialized engineering analysis, drive automated manufacturing, and integrate proprietary applications with ProE.

Interactively, when the user wants to modify the design models, he/she just selects the “Modify” button and the dimensions of the selected feature show up. The user needs to pick the dimensions he/she wants to modify, enter new values, and then ask the system to “Regenerate” the part. The model is updated according to the modified values. This becomes difficult if the task needs to be performed non-interactively. The invention enters the database of ProE through ProDevelop™, finds the dimensions of the selected part, changes the part values to the dimensions that the user wants to modify, sends the changed values to the CAD system and lets the system regenerate the part. A flowchart 246 of a process for modifying dimensions of a part is shown in FIG. 46. This figure shows a logical overview for design changes of a part within ProE.

In the virtual assembly environment, the user can pick a part, recognize the part and assemble the part. When the user wants to perform some design modification to a part, the invention starts the ProD application program, tells the ProD application the part we want modify, asks ProD to go into ProE database to find the part, extracts the dimensions, sends the dimensions to virtual environment, does the changes in the virtual environment, sends the changed dimensions back to ProD, asks ProD to update the part and reloads the part into the virtual environment, as shown in a flowchart 248 in FIG. 47. In this figure, the VAE system and ProE operate separately during the design modification process.

The first problem of this method is that the virtual system can hang during the design process since it will take several minutes to just start a ProE session. Also, it will take some time to search the ProE database to find the part and extract the dimensions. Therefore, to accelerate the process, the time to start ProD should be eliminated and the time for searching the database should be reduced. To accomplish these goals, the ProD application process should be running in parallel with the invention.

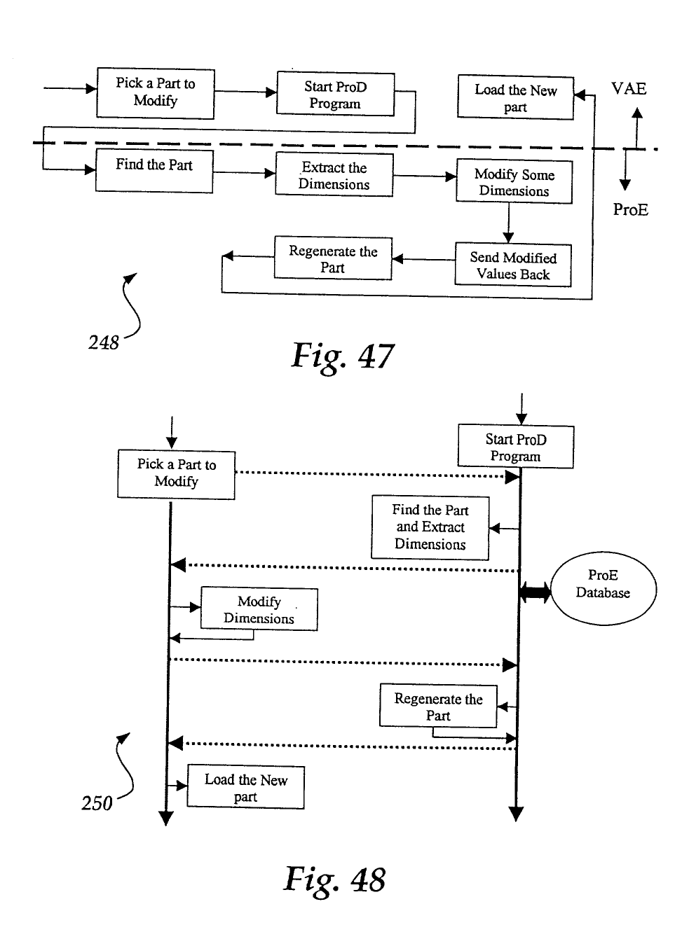

When two processes are running in parallel, it is natural to use signal handling methods and functions to set up communications between the two processes. In FIG. 48, a schematic overview 250 is shown for parallel operation of ProD and the VAE system. In this figure, the dashed arrows mean signal sending. This parallel method is much better than the non-parallel method since a bi-directional connection is established. However, it also has some problems. First, there is too much signal handling. Please note that ProE is also running in parallel with ProD and there are lots of signal communications between them. Second, although signal handling will not slow down the VAE system, it is not clear where the invention is when a signal comes from ProD. In this situation, it will be difficult to determine when and how to continue the design process. Thirdly, it is not easy to use the same ProD session for several different VAE sessions (starting a ProE session needs several minutes). Therefore, this integration architecture can be improved in several ways.

One improvement is to reduce the signal handling between the VAE system and the ProD. If several sessions of the VAE system use the same session of ProD, the invention can know the ProD process and it is not necessary for ProD to know the different VAE sessions. Secondly, once the “Design Mode” in VADE is selected, the status of the information processing and supply from ProD is checked before anything else is executed. This requires that the VAE system knows the status information directly in ProD all of the time, not just when a signal arrives. However, ProD also needs to know the data processing in the VAE system. A data sharing requirement between the two processes leads to a method of using shared memory provided by the operating systems.

The status flags of the two VAE and ProD systems are placed into shared memory, which is initialized by ProD. The data structure of the shared memory is defined as:

struct CommunicationData{
int ProD_PID; /*holding the pid of ProD*/

| | | |
|---|---|---|
| int | requestDimension; | /*ask ProD to get dimensions*/ |
| int | dimensionReady; | /*tell VADE dimension ready*/ |
| int | dimensionChanged; | /*tell ProD dimension modified*/ |
| int | partRegenerated; | /*tell VADE part regenerated */ |
| char | *partName; | /*holding the part name */ }; |

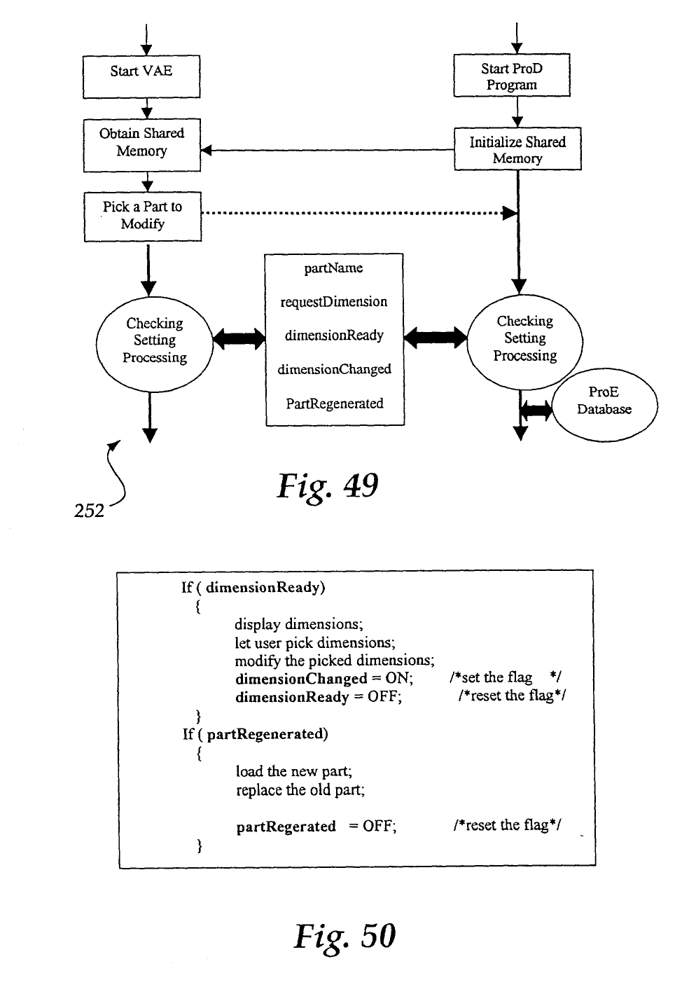

In the data structure, ProD_PID holds the process id of ProD. Since the shared memory is initialized by a ProD process, this value can be obtained by a simple system call. One reason to set a PID is that design modification is just one feature of the VAE system and it can communicate with ProD when a user wants to perform design modifications. At that time, the VAE system sends a signal to ProD and starts the communication. Here, one signal from the VAE system to ProD is needed. In FIG. 49, a schematic overview is shown for the VAE system and ProD using shared memory. This figure illustrates a parallel method of design modification in the VAE system through the CAD system using a shared memory that employs one signal between the VAE system and ProD.

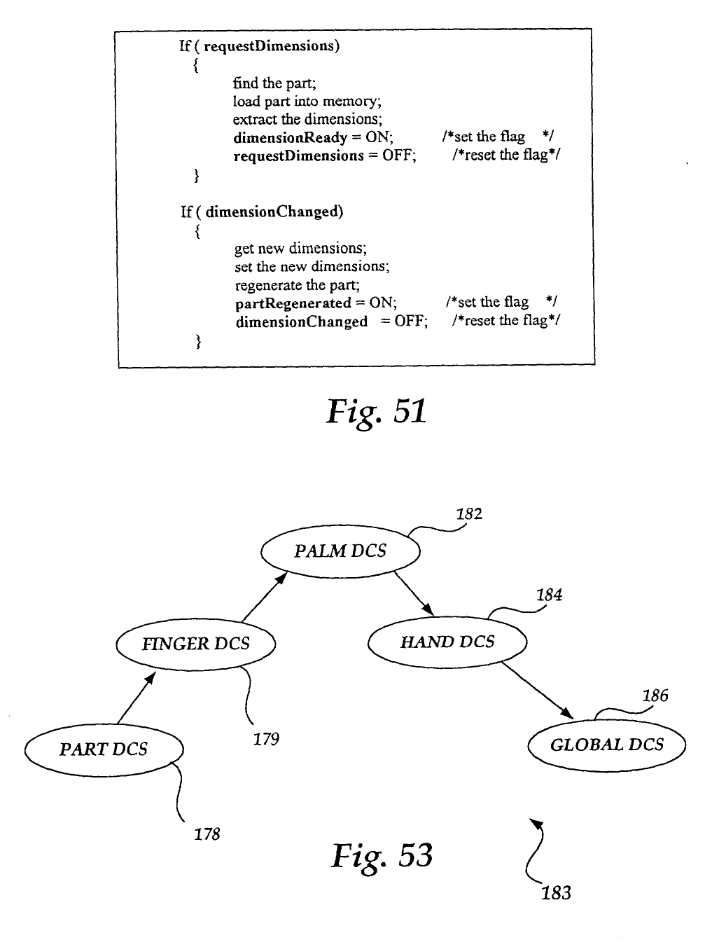

The pseudo-code of “checking, setting, processing” on the VAE system side is illustrated in FIG. 50 and the pseudo-code of “checking, setting, processing” on ProD side is shown in FIG. 51. Please note that the “requestDimension” flag is set when the user picks a part and indicates he/she wants to modify the part.

In the pseudo-code, the flags are set up and checked in different processes. “requestDimensions” and “dimensionChanged” are set in the VAE system and checked in ProD, while “dimensionReady” and “partRegenerated” are set in ProD and checked in the VAE system. This procedure makes sure that the flags are harmonized and the VAE system and ProD know the status of each other all of the time.

Usually, even a simple part has many dimensions. In the VAE sytem, in most cases, the user only wants to modify several key dimensions. So a dimension “filtering” mechanism is set up. In the part design session, the dimensions are identified that the users are allowed to change and they are named using a predefined convention. The method used to name the dimensions that are going to be modified start with “vade_”. For instance, “vade_length”, “vade_diameter”, “vade_outerdia”, etc. When looping through the dimensions, the names of the dimensions are checked first and a dimension is extracted if its name follows this convention.

The interaction between the user and the graphics system is through a “3D Gui”, a 3D graphical user interface library. The Gui can display buttons, tiles, and messages, and also can handle the selections of the buttons. In the VAE system, the “3D Gui” displays the dimensions and the user selects the dimensions. However, the user can input modified values from the keyboard because entering floating numbers from a “3D Gui” is not always practical.

Although the mechanism discussed above is fast enough to perform design modifications, there are still cases where the user wants to go back to stages before the design changes if he/she is not satisfied with the modification results. So an “undo change” mechanism is provided. Before a newly modified part is loaded into the VAE system, the old part is backed up. If the user wants to “undo change”, the invention switches back to the old saved part. If the user wants to keep the new part, then the old part is deleted.

The achievement of fast design modifications in virtual environment through the CAD system can greatly enhance the viability and functionality of the applications of virtual reality technology in design and manufacturing. It proves that virtual reality can go beyond the functionality of just being a visualization tool and serve an important role in the integration and extension of CAD systems.

### FINGER TWIRLING

The model for the virtual hand can be enhanced for more accurate performance and simplified incorporation of haptic feedback. For example, the simulated skin of the virtual hand can be improved as the number of sensors around the fingers of the CYBERGLOVE are increased. Instead of checking for the release status of a gripped part, every frame, the gripped part is checked for gripping conditions again so that an improperly gripped part would be dropped. Also, a part can be twirled if it is gripped by the same two fingers as in the two previous frames. Basic mechanical principles are applied to determine the amount of twirl based on finger movement.

The virtual skin on the fingers of the virtual hand are simulated through sensors which are line segments attached to the fingers. For each frame, the endpoints of these line segments are used for intersection traversal. Twenty four line segments are used for each finger in three circles of nine, equispaced. Five sensors are set up on the palm to enable the gripping of parts between the fingers and the palm. The two point gripping method is used to decide the gripping status of the parts. Since the number of sensors has increased, the skill level for a user is reduced which prevents the parts to be gripped unrealistically. To prevent parts from being grabbed on the rear side of the hand, the sensor pair is checked if it forms a feasible combination for fair gripping before evaluating the two point gripping method.

The gripping status of a grabbed part is checked every frame. In the other model discussed above, a part once gripped would is made a child object of the hand. This resulted in the part following the wrist translational and rotational motions. The part would not be available for intersection traversal as it moved from the global DCS and was made the child of the palm DCS. This prevented the gripping status of the gripped part to be checked every frame.

Twirling involves the manipulations of a part usually using mainly finger movements. This functionality is important to define a hand model as dexterous. Twirling is accomplished in two steps. First, a part is grabbed and in the second step it is twirled by the finger movements. The gripping status of a part is recorded and checked by the InteractionManager discussed above and the functions of the hand class are called when the part is twirled.

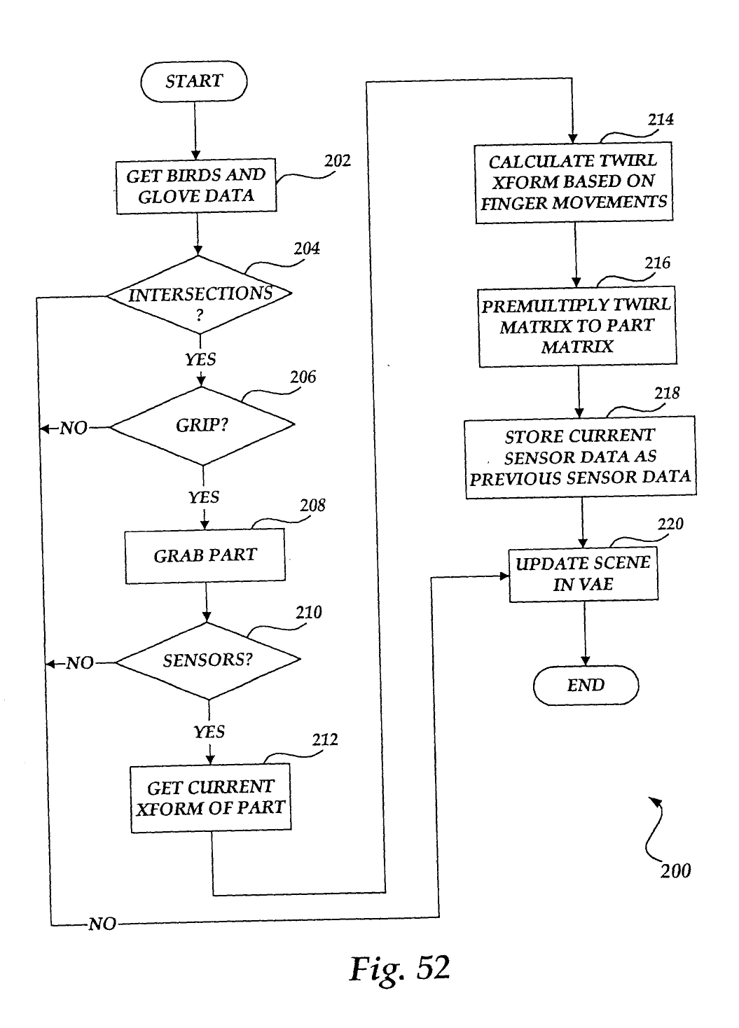

In FIG. 52, a flow chart 200 illustrates the twirl process for the hand model. Moving from the start block, the logic advances to a block 202 where sensor data is retrieved from a CYBERGLOVE and a FLOCK OF BIRDS virtual reality device. The logic flows to a decision block 204 where a determination as to whether an intersection with a part is detected. If false, the logic moves to a block 220 where the scene is updated in the VAE system and then the logic steps to an end block and terminates. However, if the determination at the decision block 204 is true, the logic advances to a decision block 206. A determination is made as whether the user is attempting to grip the part. If false, the logic moves to the block 220 and repeats substantially the same actions discussed above. But, if the determination is true at the block 206, the logic moves to a block 208 where the part is grabbed by the virtual fingers of the virtual hand.

At the decision block 210, a determination is made as to whether the CYBERGLOVE sensors are gripping the part. If false, the logic moves to the block 220 and repeats substantially the same logic discussed above. Else, the logic moves to a block 212 where the current transform of the gripped part is determined. The logic advances to a block 214 where the twirl transform is calculated based on the finger movements of the user of the CYBERGLOVE. Next, the logic steps to a block 216 where the twirl matrix is premultiplied by the part matrix. The logic advances to a block 218 where the current sensor data from the CYBERGLOVE is stored as previous sensor data. The logic flows to a block 220 and updates the scene in the VAE system. Lastly, the logic moves to the end block and terminates.

Additionally, in FIG. 53, a scene graph 183 of the dynamic coordinate systems (DCS) for twirling a virtual part with virtual fingers in the VAE system is illustrated, which is similar to the other scene graphs discussed above. However, in this case, the part DCS 178 is under a finger DCS, which is directly under the palm DCS 182. Also, the palm DCS 182 is under the hand DCS 184 is directly under the global DCS 186.

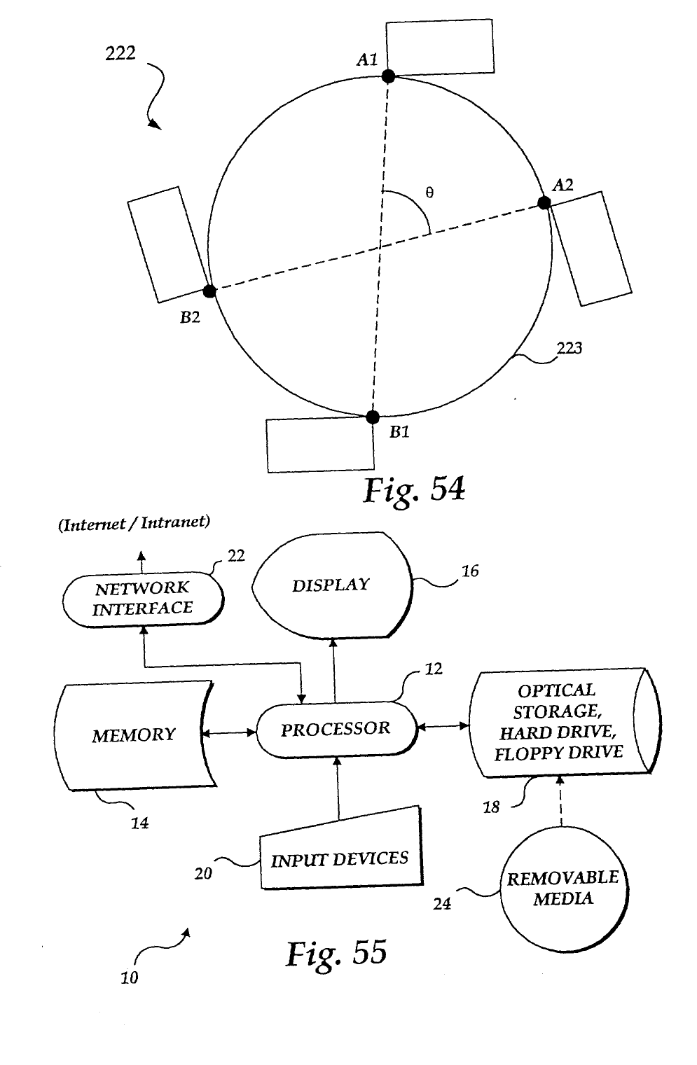

FIG. 54 illustrates a schematic overview 222 of finger locations on a part for twirling. Initially, a first finger gripping point and a second finger gripping point are disposed at A1 and B1, respectively, on a part 223. After twirling, the new gripping points of the first finger and the second finger are A2 and B2, respectively. The angle between the initial gripping points and the second gripping points is represented by θ.

Consider the two gripping points \vec{A}₁ and \vec{B}₁ in frame “n.” In frame “n+1”, the two gripping points occupy the positions \vec{A}₂ and \vec{B}₂ respectively. The axis of rotation of the part passes through the origin in the direction of \vec{θ}. This axis \vec{θ} can be calculated using the following relation

\vec{B}₂−\vec{B}₁=(\vec{A}₂−\vec{A}₁)+\vec{θ}×(\vec{B}₁−\vec{A}₁) (5.1)

The three components of rotation are given by the following equations

$$\begin{matrix}{{θ}^{->}}_{z} = \frac{( {{θ}^{->}}_{x} \times {{BA}^{⟶}}_{z} ) + {{R}^{->}}_{y}}{{{BA}^{⟶}}_{x}} & ( 5.2 ) \\ {{θ}^{->}}_{y} = \frac{( {{θ}^{->}}_{x} \times {{BA}^{⟶}}_{y} ) - {{R}^{->}}_{z}}{{{BA}^{⟶}}_{x}} & ( 5.3 )\end{matrix}$$

Assuming there is no slip,

(\vec{B}₁−\vec{A}₁)×\vec{θ}=0 (5.4)

We obtain \vec{θ}ₓ

$${{θ}^{->}}_{x} = \frac{( {{R}^{->}}_{z} \times {{BA}^{⟶}}_{y} ) - ( {{R}^{->}}_{y} \times {{BA}^{⟶}}_{z} )}{{{BA}^{⟶}}_{x}^{2} + {{BA}^{⟶}}_{y}^{2} + {{BA}^{⟶}}_{z}^{2}} \qquad ( 5.5 )$$

Where,

\vec{R}=(\vec{B}₂−\vec{B}₁)−(\vec{A}₂−\vec{A}₁) (5.6)

\vec{BA}=(\vec{B}₁−\vec{A}₁) (5.7)

The angle of rotation \vec{θ} of the part is given by the relation

|\vec{θ}|=\sqrt{θᵢ²+θⱼ²+θ_{z}²} (5.8)

The translation of the part \vec{T} is approximated to the average of the difference of the positions of points \vec{a} and \vec{b} as the fingers gripping the object move in opposite direction approximately by the same distance

$${T}^{->} = \frac{( {{B}^{->}}_{2} - {{B}^{->}}_{1} ) + ( {{A}^{->}}_{2} - {{A}^{->}}_{1} )}{2} \qquad ( 5.9 )$$

All the above calculations are done in the part's co-ordinate system. The translation and rotation matrices are premultiplied to the current part matrix in the Global space.

FIG. 55 illustrates a system for a client 10 comprising components of a computer suitable for executing an application program embodying the present invention. In FIG. 55, a processor 12 is coupled bi-directionally to a memory 14 that encompasses read only memory (ROM) and random access memory (RAM). ROM is typically used for storing processor specific machine code necessary to bootup the computer comprising client 10, to enable input and output functions, and to carry out other basic aspects of its operation. Prior to running any application program, the machine language code comprising the program is loaded into RAM within memory 14 and then executed by processor 12. Processor 12 is coupled to a display 16 on which the visualization of the HTML response discussed above is presented to a user. Often, programs and data are retained in a nonvolatile memory media that may be accessed by a compact disk-read only memory (CD-ROM) drive, compact disk-read/write memory (CD-R/W) drive, optical drive, digital versatile disc (DVD) drive, hard drive, tape drive and floppy disk drive, all generally indicated by reference numeral 18 in FIG. 55. A network interface 22 couples the processor 12 to a wide area network such as the Internet.

As noted above, the invention can be distributed for use on the computer system for the client 10 as machine instructions stored on a memory media such as a floppy disk 24 that is read by the floppy disk drive. The program would then typically be stored on the hard drive so that when the user elects to execute the application program to carry out the present invention, the machine instructions can readily be loaded into memory 14. Control of the computer and selection of options and input of data are implemented using input devices 20, which typically comprise a keyboard and a pointing device such as a mouse (neither separately shown). Further details of system for the client 10 and of the computer comprising it are not illustrated, since they are generally well known to those of ordinary skill in the art.

As described in detail above, the invention presents a complete scenario for assembly design. Multiple parts can be manipulated efficiently for assembly evaluations. Constrained motion simulation and dynamic simulation assist the assembly evaluation operation. The overall process is simulated realistically mimicking the physical assembly processes. Dynamic behaviors of objects in the virtual environment are implemented using physical laws and increases realistic feeling.

Interactive editing of assembly path and swept volume directly by the user is achieved in the virtual environment. The editing includes swept instance addition, removal, and modifications of positions and orientations. The editing of the swept volume before the assembly geometry is finalized ensures the validity and significance of the swept volume. The swept volume is also converted to a parametric model and loaded back into the CAD system for further evaluation. Collision detection functionality is also provided in the VAE system.

Bi-directional interaction is achieved between the VAE and CAD systems. For relatively simple parts, the interaction cycle is real-time. For sophisticated parts with many dimensions, the interaction speed may be slower. However, with more powerful computers, real time interaction could be achieved with even the most complex parts.

Test cases have been carried out with models from industry. Results from the invention compare very well with results from the Boothroyd methodology (which is widely used in industry) for predicting assembly time.

A significant deviation from reality occurs in the process of gripping the part. This occurs primarily from the “sluggishness” of VR systems created by tracking frequency, tracking latency, frame rates, and graphics latency. This sluggishness does not seem to affect gross motor movements (moving a part into place and aligning it) except in acute situations with large data bases. However, it significantly affects fine motor movements (e.g. finger and wrist movements).

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for providing a virtual environment for simulating the arrangement of a plurality of parts into an assembly, comprising:
(a) creating a model in a design environment for each part, each model having a geometry that corresponds to a part;
(b) translating each model into a virtual part in the virtual environment, the design environment being integrated with the virtual environment; and
(c) enabling each virtual part to be positioned in an assembly within the virtual environment, wherein the positioning of each virtual part enables a simulation to be performed for the arrangement of the plurality of parts into the assembly.

2. The method of claim 1, further comprising, enabling the simulation to be modified, a modification enabling another simulation to be performed, and when the modification causes a change in the virtual part, causing the corresponding model to automatically include the change to the virtual part.

3. The method of claim 1, further comprising, receiving a user controlled command by a virtual reality peripheral device for arranging of the plurality of parts into the assembly.

4. The method of claim 1, wherein the virtual environment is formed by a generation of three-dimensional views.

5. The method of claim 1, farther comprising, providing a menu display in the virtual environment, the menu display configured to receive commands from a user by the use of a virtual reality peripheral device.

6. The method of claim 1, further comprising, translating a constraint information set of the plurality of parts from a parametric computer aided system to the virtual environment.

7. The method of claim 6, wherein the constraint information set comprises multiple constraint values.

8. The method of claim 6, wherein the constraint information set is used to define kinematic motions of the virtual parts.

9. The method of claim 1, further comprising, translating a geometry information set of the plurality of parts from a parametric computer aided system to the virtual environment.

10. A method for processing constraint information set for limiting the motion of a part associated with the constraint information set, comprising:
comparing the part constraint information set with a predetermined constraint information set; and
limiting the motion of the part to only move about an axis, if the predetermined constraint information set dictates a limitation about an axis coordinate.

11. A method for processing a constraint information set for limiting the motion of a part associated with the constraint information set, comprising:
comparing the constraint information set with a predetermined constraint information set; and
limiting the motion of the part to only move about a plane, if the predetermined constraint information set dictates a limitation about a plane.

12. A method for processing multiple constraint information sets for simulating the moment of a first and second part in a computer simulated virtual environment, wherein a first constraint information set is associated with the first part, and wherein a second constraint information set is associated with the second part, the method comprising:
determining the presence of a predetermined type of movement between the first and second parts; and
associating the first and second constraint information sets, if there is a presence of a predetermined type of movement between the first and second parts.

13. The method of claim 12, further comprising:
determining the presence of redundant data in the first and second constraint information sets; and
determining the presence of a predetermined type of movement between the first and second coordinate indicator, if the first and second constraint information sets do not contain redundant information.

14. The method of claim 12, wherein the first and second constraint information sets define an axis.

15. The method of claim 12, wherein the first and second constraint information sets define a plane.

16. The method of claim 12, wherein the predetermined type of movement includes a first and second constraint information each define a first and second axis, wherein the first and second axis are parallel with respect to each other.

17. The method of claim 12, wherein the predetermined type of movement includes a first and second constraint information each define a first and second plane, wherein the first and second planes are not parallel with respect to each other.

18. The method of claim 12, wherein associating the first and second constraint information sets includes snapping the first part with the second part.

19. A system for providing a virtual environment, the system comprising:
a parametric computer aided drawing system having an avatar communicatively connected the parametric computer aided drawing system;
a virtual assembly design environment system communicatively connected the parametric computer aided drawing system;
program code for simulating the arrangement of a plurality of parts into an assembly in a virtual environment, which when executed, perform the steps of:
creating a model in a design environment for each part, each model having a geometry that corresponds to a part;
translating each model into a virtual part in the virtual environment, the design environment being integrated with the virtual environment; and
enabling each virtual part to be positioned in the virtual environment, the positioning of each virtual part enables a simulation to be performed for the arranging of the plurality of parts into the assembly.

20. The method of claim 19, wherein the program code, which when executed, further performs the step of, enabling the simulation to be modified, a modification enabling another simulation to be performed, and when the modification causes a change in the virtual part, causing the corresponding model to automatically include the change to the virtual part.

21. The system of claim 19, further comprising a database containing information pertaining to trajectory and sequence information for each part.

22. The system of claim 19, wherein the avatar includes one or more virtual reality peripheral devices for generating electronic signals that dictate the movement of a user.

23. The method of claim 19, wherein the program code further performs the step of providing a menu display in the virtual environment, the menu display configured to receive commands from a user.

24. A method for modeling interactivity between a glove and a part, comprising:
simulating a virtual glove grabbing a virtual part, where the simulated movements of the virtual glove correspond to movements sensed by the glove with respect to the part;
calculating a twirl transform, wherein the twirl transform is based on the movements of the glove; and
utilizing the twirl transform to generate a plurality of images of the virtual glove and the virtual part, thereby modeling the interactivity and movement of the virtual glove and the virtual part.

25. The method of claim 24, further comprising:
determining the intersection between the hand and the part;
determining the if a user is attempting to grip the part, if the hand and the part intersect; and
simulating a virtual glove grabbing a virtual part, if a user is attempting to grip the part.

26. The method of claim 24, further comprising, receiving a data set from the virtual hand, wherein the data set dictates the movement of the virtual hand.

27. A system for providing a virtual environment, the system comprising:
a computer aided drawing system having an avatar communicatively connected the parametric computer aided drawing system;
a virtual assembly design environment system communicatively connected the computer aided drawing system;
program code for modeling interactivity between a hand and a part, which when executed, perform the steps of:
calculating a twirl transform, wherein the twirl transform is based on the movements of the glove; and
utilizing the twirl transform to generate a plurality of images of the virtual glove and the virtual part, thereby modeling the interactivity and movement of the virtual glove and the virtual part.

28. The system of claim 27, wherein the avatar includes a glove having a palm and a plurality of fingers for generating electronic signals that dictate the movement of a user.

29. The system of claim 28, wherein the glove includes a plurality of sensors attached to the palm for sensing the gripping of the parts between the palm and the plurality of fingers.

30. The system of claim 28, wherein the glove includes five sensors attached to the palm for sensing the gripping of the parts between the palm and the plurality of fingers.

31. The system of claim 28, wherein the glove includes a plurality of line segments in the plurality of fingers for sensing the amount of twirl in the plurality of fingers.
